(19) United States
(12) Patent Application Publication
(10) Pub. No.: US 2026/0323785 A1
(43) Pub. Date: Oct. 15, 2026

(54) METHOD AND DEVICE FOR PRODUCING A FILM BODY, FILM BODY, METHOD FOR PRODUCING A LAYER COMPOSITE, LAYER COMPOSITE, METHOD FOR PRODUCING A HEATING FILM COMPOSITE, HEATING FILM COMPOSITE, AND DEVICE

(71) Applicant: LEONHARD KURZ Stiftung & Co. KG, Fürth (DE)

(72) Inventors: Martin HAHN, Fürth (DE); UIrich SCHINDLER, Fürth (DE); Jörg BACHSCHUSTER, Fürth (DE)

(21) Appl. No.: 19/475,516

(22) PCT Filed: Apr. 10, 2024
(86) PCT No.: PCT/EP2024/059692

§ 371 Date: Oct. 15, 2025

(30) Foreign Application Priority Data
Apr. 17, 2023 (DE) 10 2023 109 577.3
Jul. 7, 2023 (DE) 10 2023 117 997.7

(51) Int. Cl. H05B 3/84; B29C 45/14; B29L 31/30

(52) U.S. Cl. CPC H05B 3/84; B29C 45/14467; B29L 2031/30

(57) ABSTRACT

A method for producing a film body, to a film body, to a layer composite, and to a device for producing a film body. The film body includes at least one carrier film, at least one decorative layer, and at least one heating wire with a minimum width and/or a minimum diameter of 50 μm and a minimum cross-sectional surface area of 2500 μm² and/or a multi-wire heating line including at least one heating wire and one or more additional heating wires. The at least one heating wire and the one or more additional heating wires are provided so as to be at least partly galvanically isolated from one another, and the at least one decorative layer is optional in the case of the multi-wire heating line. The components of the film body are provided with a first support component in the film body and with a second support component on a visible face.

The invention relates to a method of producing a film body, to a method of producing a layer composite, to a method of producing a heating film composite, to an apparatus for producing a film body, and to a film body, a heating film composite and a layer composite.

The use of decorative covers of vehicle parts having transparent metal layers is a known means of heating surfaces. Such metal layers can be vapor-deposited with low layer thickness. On the one hand, the low thickness of the vapor-deposited material enables transmission of electromagnetic waves from radiation sources covered thereby. On the other hand, the heating output is limited by the small amount of vapor-deposited material. However, because of the increasing use of light sources with very low heat output, which are additionally in positions exposed to adverse weather conditions, for example LED headlights with and without integrated radar devices on the front of vehicles, there are now increasing demands on the design of these heaters. In order to ultimately achieve a desired heating effect, large heating areas based on thin metal layers may be needed, or even long heating tracks extending over the areas to be heated. This in turn increases manufacturing-related tolerances and possible delamination of these metal layers or long heating tracks, especially in molding regions under high mechanical stress. This can reduce design options, for example the use of further layers to decorate the cover. Such products are therefore relatively delicate, the production of reliable products is complex, and the possible uses in terms of heating output and integration into a decorative overall concept are reduced.

Heating means in other applications, for example with a pure heating function without decoration, can adversely affect transmission for particular electromagnetic waves and optical properties, since they are opaque and/or reflective owing to the materials used and/or large dimensions, for example for the radiation from radar devices or the light beams from headlights.

It is thus an object of the invention to provide improved options for heatable covers, and also for a method and for an apparatus for producing heatable covers.

The object is achieved by a method of producing a film body as claimed in claim 1, a method of producing a layer composite as claimed in claim 18, a layer composite as claimed in claim 38, a method of producing a heating film composite as claimed in claim 17, a heating film composite as claimed in claim 37, a film body as claimed in claim 48 and an apparatus as claimed in claim 49.

The object is achieved by a method of producing a film body having a heatable surface of a cover element which is transmissive for electromagnetic waves in particular, comprising the following steps, in particular in the sequence specified:
a) providing at least one carrier film, at least one decorative ply and at least one heating wire, where the at least one heating wire has a minimum width and/or a minimum diameter of 50 μm and a minimum cross-sectional area of 2500 μm² and/or providing:
at least one carrier film,
optionally at least one decorative ply, and
a multicore heating conduit comprising at least one heating wire and one or more further heating wires, where the at least one heating wire and the one or more further heating wires are at least partly galvanically isolated from one another,
b) in-mold coating or flow coating the at least one carrier film and/or the at least one heating wire and/or the at least one decorative ply with a first free-flowing composition to obtain a first carrier component of the film body;
c) applying at least a second free-flowing composition to a front side proceeding from the at least one carrier film to obtain a second carrier component and/or a protective varnish layer on a visible side of the film body.

The object is additionally achieved by a method of producing a layer composite, in particular in the form of an insert element, preferably for use in the method of producing the film body. The method of producing the layer composite comprises the steps of:
i) providing at least one carrier film,
ii) providing at least one decorative ply and
iii) providing at least one heating wire having a minimum width and/or smallest diameter of 50 μm and a minimum cross-sectional area of 2500 μm² and/or a multicore heating conduit comprising at least one heating wire and one or more further heating wires, wherein the at least one heating wire and the one or more further heating wires are at least partly galvanically isolated from one another,
iv) bonding, preferably cohesively bonding, the at least one carrier film, the at least one decorative ply and the at least one heating wire. Preferably, the method of producing the layer composite, or one or more steps thereof, is performed in the method of producing the film body, in particular prior to step a) or as one or more component steps of step a) and/or step b) and/or step c).

The object is further achieved by a layer composite, in particular in the form of an insert element, preferably produced by the method of producing a layer composite and/or for use in a method of producing a film body. The layer composite comprises:
at least one carrier film,
at least one decorative ply and
at least one heating wire having a minimum width and/or smallest diameter of 50 μm and a minimum cross-sectional area of 2500 μm² and/or a multicore heating conduit comprising at least one heating wire and one or more further heating wires, wherein the at least one heating wire and the one or more further heating wires are at least partly galvanically isolated from one another,
wherein the at least one carrier film, the at least one decorative ply and the at least one heating wire are bonded, preferably cohesively bonded.

The object is further achieved by a method of producing a heating film composite. The method of producing the composite comprises the steps of:
I) providing at least one carrier film,
II) optionally providing at least one decorative ply,
III) providing a multicore heating conduit comprising at least one heating wire and one or more further heating wires, where the at least one heating wire and the one or more further heating wires are at least partly galvanically isolated from one another,
IV) bonding, preferably cohesively bonding, the at least one carrier film and the multicore heating conduit and optionally the at least one decorative ply.

The object is further achieved by a heating film composite comprising at least one carrier film and a multicore heating conduit. The multicore heating conduit comprises at least one heating wire and one or more further heating wires, where the at least one heating wire and the one or more further heating wires are at least partly galvanically isolated from one another. The heating film composite optionally comprises at least one decorative ply. The at least one carrier film and the at least one heating wire and optionally the at least one decorative ply are bonded, preferably cohesively bonded.

The heating film composite is in particular in the form of an insert element. Preferably, the heating film composite, in particular as an insert element, serves for and/or is suitable for the purpose of use in a method of producing the film body and/or in a method of producing the layer composite. The heating film composite may be a composite referred to as the first composite.

The object is achieved by a film body, in particular produced by the method of producing the film body and/or preferably the method of producing the layer composite and/or the method of producing the heating film composite, in particular the first composite. The film body has a heatable surface of a cover element which is transmissive in particular for electromagnetic radiation and comprises at least one carrier film, at least one decorative ply and at least one heating wire having a minimum width and/or a smallest diameter of 50 μm and a minimum cross-sectional area of 2500 μm², and/or the film body comprises at least one carrier film, optionally comprises at least one decorative ply, and comprises a multicore heating conduit. The multicore heating conduit comprises at least one heating wire and one or more further heating wires, where the at least one heating wire and the one or more further heating wires are at least partly galvanically isolated from one another. In particular, the film body comprises the layer composite according to the invention and/or the heating film composite according to the invention, preferably the first composite. In addition, the film body comprises a first carrier component and a second carrier component and/or a protective varnish layer, wherein the second carrier component and/or the protective varnish layer are formed on a visible side of the film body.

The object is achieved by an apparatus, in particular injection molding apparatus, preferably for performing the method of producing the film body. The apparatus comprises:
means of forming a cavity. The means of forming a cavity have at least a first mold shape and a second mold shape which are movable into a closed state in which the cavity is formed by at least the first mold shape and the second mold shape. The at least one first mold shape and one second mold shape are preferably designed such that an insert element, in particular the layer composite, is within the cavity in the closed state and is coatable by the first free-flowing composition, in particular in a first clearance, and/or by the second free-flowing composition, in particular in a second clearance.

Means of forming a defined slit adjacent to the cavity. The means of forming the defined slit adjacent to the cavity have at least a first slit shape and a second slit shape, wherein the slit is formed in the closed state of at least the first slit shape and the second slit shape. At least one of the first slit shape and the second slit shape is connected to the first mold shape and/or to the second mold shape via a releasable connecting element. The slit is configured in particular such that a portion of an insert element, in particular the contacting element, preferably of the layer composite, can be led out of the cavity in the closed state.

In this way, a film body is obtainable, which can provide a particularly strong heating function by means of the heating wire and/or the multicore heating conduit. At the same time, an improved heat distribution can be achieved, in particular owing to the embedding of the heating wire and/or the multicore heating conduit within a preferably closed plastic body. It is thus possible, in poor weather conditions, for example, to improve the reliability of the sensors for distance measurements, and also to enable rapid illumination, uniformly in operation, of the road surface in the case of headlights when switched on. This achieves high flexibility in terms of decorative options.

In particular, it is possible to provide optional layers of the film body and/or of the layer composite and/or of the heating film composite, and also the second carrier component, which are arranged between the surface to be heated and the heating wire, with decorative elements and at the same time to optimize them for the distribution of heat, such that the heat is distributed in the second carrier component so as to achieve more uniform heating of the surface to be heated on the visible side. This means that the design options for the film body, in particular the second carrier component on the visible side, are also improved, for example when the surface of the visible side is to have a greater distance from the heating wire. Furthermore, by means of the at least one decorative ply, the heating function can be concealed from an observer, integrated within the design, or even visibly highlighted. In addition, it is possible to use the several heating wires of the multicore heating conduit in order to achieve sufficient heating output with inexpensive materials (for example with a high copper content), with utilization of the several heating wires simultaneously for special decorative effects. For example, the multicore heating conduit may have a surface structure which is formed by the heating wires and/or by outer layers, each of which encases a heating wire. In addition, the multicore heating conduit offers various means of positioning special color effects visibly in the film body. It is possible, for example, to provide several outer layers, for example different-colored baking varnish layers, each around the individual heating wires and for these to be formed in such a way that the heating conduit has a locally changing color effect and/or locally changing brightness effect and/or shows different colors at different viewing angles. In addition, the arrangement of the heating wires relative to one another can be used to achieve further special optical effects, for example by means of parallel, twisted and/or curved heating wires. In addition, the multiple heating wires can provide better visibility compared to a single heating wire in that a larger contiguous area of the multicore heating conduit is occupied. Furthermore, the outer layers or further layers with which the heating wire is provided can be processed further, for example by means of a laser. This can achieve, for example, simplified individualization of a decoration, an improved setup time and/or improved batch size. A sufficient heating output can be ensured, especially when copper is used, in spite of a low specific resistivity, by controlled adjustment of the total resistance of the multicore heating conduit. For this purpose, the number of heating wires, the structure and cross section of the multicore heating conduit and the diameter of the respective heating wires can be adjusted and optimized in the final film body, in particular according to the requirements. The multicore heating conduit thus provides a large number of “adjusting screws” in terms of heating output and decorative effects.

Advantageously, it is possible in particular in the film body that, by means of the at least one heating wire in combination with the at least one decorative ply, and also by means of the multicore heating conduit, a special decorative function is achieved with simultaneous provision of sufficient heating output.

An additional advantage of the multicore heating conduit is that it can be designed as a particularly flexible conduit which allows simplified application to the at least one carrier film and/or an application with complex geometries. A further advantage of the multicore heating conduit can be considered to be an enlarged surface area compared to a single heating wire, which can improve adhesion of the embedded heating conduit in the film body, for example.

It is additionally possible to provide a particularly robust film body. For instance, it is possible that the film body has comparatively low elasticity, as a result of which the heating wire present therein is exposed only to minor flexural stresses or vibrations. In addition, the surface of the heating wire may be comparatively small compared to its volume. For example, this makes delamination of adjacent layers in an interfacial area less likely, and also subsequent formation of moisture and corrosion. In addition, in spite of a comparatively irregular material distribution in the film body, owing to the relatively large areas of heating wire, can be formed by adhesive bridges, which at the same time enables optimal permeability for corresponding electromagnetic waves.

Owing to the partable connection of the apparatus, it is advantageously possible, by adjusting or replacing the first slit shape in a compact design, to exert a defined adequate pressure on an element of a component to be subjected to in-mold coating that has been guided through the slit, in particular the layer composite. It is thus possible to keep a region of the component, in particular of the layer composite, free of injection molding material without damage by one of the mold shapes, for example, and at the same time to ensure that no material escapes from the cavity through the slit in the course of injection molding, i.e. no “blowout” takes place.

The film body is obtainable in particular by the method of producing a film body and preferably has the features obtainable by the method of producing a film body. The layer composite is obtainable in particular by the method of producing a layer composite and preferably has the features obtainable by the method of producing a layer composite. The heating film composite, preferably the first composite, is obtainable in particular by the method of producing a heating film composite and preferably has the features obtainable by the method of producing a composite. The film body preferably comprises the layer composite and/or the heating film composite. The layer composite is preferably used or provided in the method of producing a film body. It is also possible that method steps of the method of producing the layer composite are performed in the method of producing a film body. For example, it is possible that the steps of the method of producing the layer composite are performed in or before step a) or in step b) or in step c). It is also possible that the film body has the features obtainable by the method of producing a layer composite. Preferably, the method of producing the heating film composite or one or more steps thereof is performed in the method of producing the film body, in particular before step a) or as one or more component steps of step a) and/or of step b) and/or of step c). It is also possible that one or more steps for producing the layer composite, such as steps i), ii) and iii) or i) and iii), are performed by providing the heating film composite, in particular the first composite. The heating film composite may in particular be an intermediate product for and/or in the production of the layer composite and/or the film body. The layer composite may in particular be an intermediate product for and/or in the production of the film body or else only be formed in the production of the film body as a portion of the film body. The apparatus is preferably used in the method of producing a film body and/or is configured in such a way that it is suitable for performing one or more method steps of the method of producing a film body.

The film body is preferably a vehicle part, further preferably a headlight, a vehicle interior trim part or a vehicle exterior trim part. What is meant in particular by a cover element transmissive for electromagnetic waves is a cover element for one or more radiation sources, preferably measuring devices, such as in particular radar devices, and/or lighting devices, such as in particular headlights, preferably LED headlights, preferably for a vehicle. What is meant in particular by a heatable cover element transmissive for electromagnetic waves is a cover element which is transmissive at least in some regions, preferably outside the at least one heating wire and/or the multicore heating conduit, for certain wavelengths, preferably at least for wavelengths within a range from 1 GHz to 150 GHz for radar applications and/or within a range from 350 THz to 850 THz for visible light, preferably having a transmittance, in particular for these wavelengths, of 5% to 100%. In particular, a surface of the cover element is heatable by means of the at least one heating wire and/or the multicore heating conduit. The film body may form the cover element and/or have additional layers and/or include one or more radiation sources, preferably a measuring device, in particular radar device, and/or a lighting device, in particular LED headlights.

What is meant by “transparent” is in particular having transmittance within a range from at least 70%, preferably up to 99%, in particular for radar radiation and/or visible light. What is meant in particular by “opaque” is having transmittance within a range from 0% to 70%, in particular for radar radiation and/or visible light. Transmittance can preferably be measured with a photometer.

What is meant in particular by visible to the human eye or visible light is visible especially in daylight and/or visible in the form of visible wavelengths in a range from 380 nm to 780 nm. In particular, radar radiation has wavelengths within a range from 2.4 cm to 3.75 cm.

What is meant by a layer or ply is preferably an essentially planar structure which may itself in particular be single-layer or multilayer.

The visible side is preferably a side of the film body and/or of the layer composite which is or has been envisaged for viewing by a viewer. The visible side of the film body thus in particular has a free and/or visible surface, especially in the intended use. A front side is in particular a side of an object that faces the visible side, for example of the at least one carrier film or of the layer composite or of the heating film composite, in particular of the first composite, of a layer or of a component. A reverse side is in particular a side of an object that faces away from the visible side, for example of the at least one carrier film or of the layer composite or of the heating film composite, of a layer or of a component.

What is meant in particular by minimum width is the smallest distance between two points of an outer contour of a cross section, in particular a cross section with the smallest area. In the case of a circular cross section, the minimum width corresponds to the diameter, for example.

The minimum cross-sectional area is preferably the area of a cross section having the smallest area. The minimum width and/or the minimum cross-sectional area preferably relates to a region of the heating wire with essentially constant dimensions. In particular, locally reduced minimum widths or cross-sectional areas that are optionally present or inserted later, for example by or for contacting of the heating wire with an energy source, should preferably not be used for determination of the minimum width and/or the minimum cross-sectional area. The minimum width and/or minimum cross-sectional area is preferably measured without taking account of optional insulation.

In the case of the multicore heating conduit, it is possible in particular that dimensions, such as a width, in particular a minimum width, and/or a diameter of the multicore heating conduit relate to the multicore heating conduit including optional layers, such as outer layers, preferably insulation layers and/or baking varnish layers. In particular, locally reduced or increased widths or diameters that are optionally present or inserted later, for example by or for contacting of the multicore heating conduit with an energy source, should preferably not be used for determination of the minimum width and/or the minimum cross-sectional area.

It is possible that the at least one heating wire has either the abovementioned minimum dimensions or the at least one heating wire is encompassed by a multicore heating conduit. However, it is also possible that the at least one heating wire of the multicore heating conduit has the abovementioned minimum dimensions. In particular, if a multicore heating conduit is provided, the at least one decorative ply is optional. The heating film composite, in particular the first composite, can therefore be considered in particular to be the layer composite, but may also refer to a composite without a separate decorative ply. The heating film composite may thus correspond to the layer composite in preferred versions having at least one decorative ply and the corresponding dimensions of the at least one heating wire. In particular, the multicore heating conduit of the heating film composite, in particular of the first composite, may itself already have a decorative function different, for example, from the visual appearance of a single heating wire which is supplemented with the at least one decorative ply in the layer composite. However, properties and/or steps related to the at least one heating wire are in particular also conceivable with regard to the at least one heating wire of the multicore heating conduit.

In particular, it is possible that the abovementioned object is achieved by means of a layer composite or heating film composite, preferably first composite, in particular in the form of an insert element, preferably produced by the method of the invention and/or for use in the method of the invention,
comprising at least one carrier film and comprising at least one heating wire, where the at least one heating wire A) has a minimum width and/or smallest diameter of 50 μm and a minimum cross-sectional area of 2500 μm² and/or B) is encompassed by a multicore heating conduit, where the multicore heating conduit comprises one or more further heating wires, where the at least one heating wire and the one or more further heating wires are at least partly galvanically isolated from one another,
where the layer composite comprises the at least one heating wire of version A) and at least one decorative ply or the heating film composite comprises the at least one heating wire of version B) and optionally at least one decorative ply,
where, in version A), the at least one carrier film, the at least one decorative ply and the at least one heating wire are bonded, preferably cohesively bonded, and, in version B), the at least one carrier film and the multicore heating conduit and optionally the at least one decorative ply are bonded, preferably cohesively bonded.

In particular, it is conceivable that the abovementioned object is achieved by a method of producing a layer composite or a heating film composite, preferably first composite, in particular in the form of an insert element, preferably for use in the method of the invention according to one, comprising the steps of:
i) providing at least one carrier film,
ii) providing at least one decorative ply, and
iii) providing at least one heating wire having a minimum width and/or a smallest diameter of 50 μm and a minimum cross-sectional area of 2500 μm²,
iv) bonding, preferably cohesively bonding, the at least one carrier film (20), the at least one decorative ply and the at least one heating wire to obtain the layer composite,
and/or comprising the steps of:
I) providing at least one carrier film,
II) optionally providing at least one decorative ply, and
III) providing a multicore heating conduit comprising at least one heating wire and one or more further heating wires, where the at least one heating wire and the one or more further heating wires are at least partly galvanically isolated from one another,
IV) bonding, preferably cohesively bonding, the at least one carrier film and the multicore heating conduit (9) and optionally the at least one decorative ply to obtain the heating film composite, in particular the first composite.

What is preferably meant by “at least partly galvanically isolated” is that the multicore heating conduit has at least one insulation that galvanically isolates several or all heating wires from one another. In particular, the multicore heating conduit, at at least one end or at two ends, has a contact site at which several or all heating wires of the at least one heating wire and the one or more further heating wires are or have been galvanically connected, i.e. in particular contacted with one another in an electrically conductive manner, and/or are galvanically connectable, i.e. are in particular contactable with one another in an electrically conductive manner.

It is thus possible that several or all heating wires of the multicore heating conduit are or have been connected in parallel or are connectable in parallel.

It is also conceivable that, in addition to the multicore heating conduit, one or more further multicore heating conduits and/or one or more further heating wires are provided. It is also possible that the at least one heating wire and/or one or more of the one or more further heating wires are each formed by a strand, in particular by a plurality of individual wires in conductive contact with one another.

What is meant in particular by a preferably locally changing color effect and/or brightness effect is that a change in viewing angle is accompanied by a change in color and/or change in brightness of the color effect and/or that, when viewed at a particular viewing angle, the color effect is cast in different colors and/or in different brightnesses in the eye of the observer in some regions.

The slit in the apparatus is in particular a slit for part of the heating film composite and/or the layer composite and/or the film body, preferably for a contacting element. In particular, the slit should not be equated with an injection channel in which, for example, a sprue can form.

Advantageous configurations of the invention are described in the subsidiary claims.

Step a) should be understood in particular such that the at least one carrier film, the at least one decorative ply and the at least one heating wire can be provided at the same time or the at least one carrier film and/or the at least one decorative ply and/or the at least one heating wire are provided at different times.

The first carrier component obtained by step b) is or has been connected, in particular on the front side and/or reverse side, in particular to the at least one carrier film, the at least one heating wire and/or the multicore heating conduit and/or the at least one decorative film. It is thus possible that, in step b), the first free-flowing composition is applied on a reverse side or on a front side, proceeding from the at least one carrier film. Preferably, the first carrier component thus is or has been arranged on a or as a reverse side of the film body proceeding from the at least one carrier film and/or proceeding from the second carrier component. It is also possible that the first carrier component is or has been positioned on a or as a reverse side of the film body proceeding from the second carrier component, and that the at least one carrier film, in particular a first carrier film of the at least one carrier film, is or has been positioned on a or as a reverse side proceeding from the first carrier component. An arrangement of the first carrier component, in particular directly or indirectly, on a front side and/or a reverse side of the at least one carrier film is preferably provided when the at least one decorative ply, preferably by an in-mold-decoration method (IMD method), is bonded to the at least one carrier film which is preferably already bonded to the at least one heating wire and/or the multicore heating conduit. The first free-flowing composition is preferably injected here between the at least one decorative ply and the at least one carrier film.

The in-mold coating or flow coating in step b) is preferably effected so as to obtain a first body comprising the first carrier component, the at least one carrier film and the at least one heating wire and/or the multicore heating conduit and optionally the at least one decorative ply. It is possible in particular that the at least one decorative ply is applied to the at least one carrier film before step b) or during step b) or is applied to the first body after step b) and in particular before step c), for example by hot stamping. In particular, it is possible that the first body is provided with the at least one decorative ply in step c) with the second carrier component and/or the protective varnish layer.

It is possible that, preferably in step a), the at least one carrier film, the at least one decorative ply and/or the at least one heating wire and/or the multicore heating conduit are provided in the form of a layer composite. Alternatively or additionally, it is possible that the at least one carrier film and the at least one heating wire and/or the multicore heating conduit are provided in step a) in the form of a first composite, which is preferably the heating film composite, preferably with the at least one decorative ply fixedly integrated into the layer composite and/or the film body in step b) or in step c), in particular by an in-mold-decoration method (IMD method). For production of the layer composite, it is conceivable that the at least one carrier film and the at least one heating wire and/or the multicore heating conduit are provided in the form of a first composite which is preferably the heating film composite, in which the at least one decorative ply is preferably integrated, in particular by an IMD method, preferably in step b) or in step c) and/or in step iv), to obtain the layer composite. Preferably, in the IMD method, the at least one carrier film and the at least one decorative ply are arranged on opposite sides of a cavity and coated by injection in between, i.e. in particular between the at least one carrier film which has preferably been provided with the at least one heating wire and/or the multicore heating conduit, and the at least one decorative ply provided with the first carrier component or the second carrier component. For this purpose, the at least one decorative ply is provided in particular as a transfer ply of an IMD film which is detachable from a carrier film, preferably with the carrier film pressed against a wall of the cavity in the course of in-mold coating.

Thus, as is apparent from the details above, but also possible independently thereof, it is possible, for example, that the bonding in step iv) for production of the layer composite is effected in or after step b) or in step c).

What is meant in particular by a layer composite or heating film composite is a composite composed of two or more layers. Preferably all layers therein are or have been held together by the layer composite or heating film composite or composite itself. Preferably, the layer composite, heating film composite or composite is self-supporting. Adhesion promoter layers and adhesive layers may be provided on and/or between layers of the layer composite or of the heating film composite or composite. It is possible that the heating film composite or the layer composite is a laminate or includes a laminate and one or more further layers, preferably where the laminate includes at least the carrier film and at least one decorative ply.

The application of the second free-flowing composition on a front side proceeding from the at least one carrier film is preferably conducted in such a way that a direct arrangement of the second carrier component and/or the protective varnish layer on the at least one carrier film is or has been formed, or that an indirect arrangement of the second carrier component and/or the protective varnish layer on the at least one carrier film is or has been formed. An indirect arrangement means in particular one with one or more intermediate layers, for example the at least one decorative ply, the at least one heating wire and/or the first carrier component.

What is meant in particular by a layer composite in the form of an insert element or a heating film composite, in particular first composite, in the form of an insert element, is a layer composite or heating film composite suitable for a coating by injection molding. In the method of producing the film body, the insert element may be placed in a cavity and processed further to give the film body and/or placed in the cavity of the apparatus and processed further, in particular to give the film body. Recesses are preferably provided, in particular for pin receptacles of the apparatus, in the insert element and/or the apparatus has pin receptacles. The recesses in the are conceivable in particular in conjunction with pin receptacles of the apparatus that engage in the recesses for positionally exact introduction of the insert element into the cavity.

Preferably, a minimum distance within a range from 0.2 mm to 4 mm, preferably of 0.9 mm, is or has been formed between the at least one heating wire and the heatable surface and/or between the multicore heating conduit and the heatable surface. Advantageously, the minimum distance can achieve an improvement in heat distribution, in particular in that a “heat cone” is formed around the at least one heating wire in the course of heating, which then heats the heatable surface correspondingly more two-dimensionally and/or homogeneously. The second carrier component preferably has a layer thickness within a range from 200 μm to 40 000 μm.

It is possible that the second carrier component is or has been formed with a thermal conductivity of more than 0.02 W/(m*K), preferably within a range from 0.02 W/(m*K) to 0.06 W/(m*K). It is also possible that thermal conductivity enhancers are or have been added to the second free-flowing composition or the second carrier component and/or that thermal conductivity reducers are or have been added to the first free-flowing composition or the first carrier component. Thermal conductivity enhancers that are or have been added to the second free-flowing composition or the second carrier component are preferably one or more of the following materials: glass and/or glass fibers, metals and/or metal fibers, inorganic additives (fillers and the like)

Thermal conductivity reducers that are or have been added to the second free-flowing composition or the second carrier component are preferably fibers of plastics, the thermal conductivity of which is lower than the surrounding plastic, in particular in a cured state.

In this context, it should preferably be taken into account that an increase or reduction in thermal conductivity through introduction of appropriate additives does not adversely affect the transmission of radar waves, for example. Targeted and optimized adjustment is thus preferred.

It is thus advantageously possible to achieve a further improvement in heat distribution directed toward the heatable surface, in particular without undesirably affecting the transmission of radar waves and the like.

Preferably, the at least one heating wire and/or the multicore heating conduit is connectable or is or has been connected to a control unit and/or an electrical energy source. The control unit is preferably configured such that, in an active heating state, the maximum temperature of the at least one heating wire and/or the multicore heating conduit is within a range from 50° C. to 75° C. and/or the maximum temperature of the at least one heating wire and/or of the multicore heating conduit is at least 20° C. or 20 K lower than the minimum temperature of glass transition temperature of the layer composite and/or of the heating film composite, in particular first composite, and/or of the film body and decomposition temperature of the layer composite and/or of the heating film composite, in particular first composite, and/or of the film body, in particular in order to avoid melting of the surrounding plastic.

The at least one heating wire is or has been provided with a varnish insulation and/or has a varnish insulation, preferably before step iv) and/or before step a). It is also possible that the at least one heating wire has no varnish insulation and/or is or has been isolated preferably only by step iv) or by at least one of steps b) and c).

The at least one heating wire comprises or preferably consists of at least one metal wire or of one or more metal layers. The at least one heating wire further preferably comprises or consists of one or more of the following materials and/or the one or more further heating wires preferably comprise or consist of one or more of the following materials: NiCr15Fe, Cu, CuNi30Mn, CuMn12Ni, constantan, 30Mn 70Cu alloy, X10CrAlSi13. It is also possible to use other materials for the at least one heating wire and/or the one or more further heating wires, provided that these in particular have sufficient conductivity and heat output. Preferably, especially at an ambient temperature of 20° C., the specific resistivity of the material is more than 0.3 Ω·mm²/m and/or the electrical conductivity is less than 3 S/m or m/Ω·mm².

In particular, for provision of the at least one heating wire in step iii) and/or the multicore heating conduit in step III) and/or in step a), it is possible that the at least one heating wire and/or the multicore heating conduit is preferably provided in the form of a wire mesh and preferably is or has been positioned on the at least one carrier film. A wire mesh is preferably self-supporting. The wire mesh may also be or have been shaped to the at least one carrier film by feeding the at least one heating wire and/or the multicore heating conduit by means of an ultrasonic sonotrode, in particular through an ultrasonic sonotrode.

It is possible that the at least one heating wire is provided in step iii) and/or in step a) in that the at least one heating wire is or has been applied to the at least one carrier film by printing, in particular multilayer printing, of one or more metal layers. Multilayer printing is in particular printing of several overlapping layers, such that, appropriately, a layer with a total layer thickness corresponding to a sum total of the layer thicknesses of the overlapping printed layers is or has been printed.

It is possible that the at least one heating wire is provided in step iii) and/or in step a) in that the at least one heating wire is or has been applied to the at least one carrier film by single- or multilayer printing of an electrically conductive varnish, preferably in conjunction with one or more corresponding drying steps on printed varnish layers of the varnish, preferably followed by one or more galvanizing application steps of the printed varnish layer and/or the printed varnish. The drying of the printed varnish layers involves, in particular, driving out solvents and/or altering the structure of the conductive particles in the varnish, so as to assist galvanization.

It is possible that, in particular after or in either of the steps iii) and iv) and/or after or in either of the steps III) and IV) or before step iv) and/or before step IV) and/or before step a), the at least one heating wire and/or the multicore heating conduit is or has been at least partly inserted into or applied to, and preferably at least partly penetrates or has penetrated into, one or more layers of the layer composite and/or the heating film composite, in particular of the first composite, and/or into the at least one carrier film, in particular into the first carrier film and/or the second carrier film, and/or the at least one heating wire and/or the multicore heating conduit is or has been inserted between two layers of the layer composite and/or the heating film composite, in particular of the first composite, and/or between the at least one carrier film and a substrate and/or between the first carrier film and the second carrier film.

It is possible that the following step is conducted, preferably after or in one of steps iii) and iv) and/or after or in one of steps III) and IV) and/or before step a):
a1) at least partly inserting the at least one heating wire and/or the multicore heating conduit into the at least one carrier film, in particular into the first carrier film or the second carrier film, in particular by penetration. It is possible that, in particular after step iv) and/or after step IV) and/or after one of steps b) and c), the at least one heating wire and/or the multicore heating conduit passes completely through one or more decorative plies of the at least one decorative layer and/or one or more decorative layers of the at least one decorative ply.

The heating wire and/or the multicore heating conduit may be or have been arranged on and/or in the at least one decorative ply and/or on and/or in the at least one carrier film, in particular in different ways. This respectively different arrangement may depend on one or more of the following conditions: energy input when fixing the heating wire and/or the multicore heating conduit on a respective backing, the material of the carrier film, the material of the heating wire, minimum width and/or smallest diameter of the heating wire and/or the multicore heating conduit, cross-sectional shape of the heating wire and/or the multicore heating conduit, dwell time of the energy input when fixing the heating wire and/or the multicore heating conduit on the respective backing, thermal conductivity of the heating wire and/or the multicore heating conduit, thermal conductivity of the decorative ply, thermal conductivity of the carrier film.

The arrangement of the heating wire and/or the multicore heating conduit, in particular this respective different arrangement of the heating wire and/or the multicore heating conduit, may, for example, be or have been provided as follows:
a) the heating wire and/or the multicore heating conduit may have been embedded in the carrier film and in the decorative ply or
b) the heating wire and/or the multicore heating conduit may have been embedded solely in the decorative ply or
c) the heating wire and/or the multicore heating conduit may have been embedded in the decorative ply and partly embedded in the face of the carrier film, depending on position, or
d) the heating wire and/or the multicore heating conduit may rest on the decorative ply and only partly be embedded in the decorative ply and not embedded in the carrier film.

It is also possible that the at least one heating wire and/or the multicore heating conduit is or has been inserted into one or more layers or parts and/or between at least two layers or parts, in particular of the heating film composite, preferably of the first composite, and/or of the layer composite and/or the film body, selected from: the first carrier component, the second carrier component, the protective varnish layer, the at least one carrier film, a first carrier film of the at least one carrier film, a second carrier film of the at least one carrier film, a substrate with a reflection layer, the at least one decorative ply, a first decorative ply of the at least one decorative ply, a second decorative ply of the at least one decorative ply.

It is possible in particular that the following step is conducted, preferably after or in one of steps iii) and iv) and/or after or in one of steps III) and IV) and/or before step a):
a2) at least partly inserting the at least one heating wire and/or the multicore heating conduit between two layers of the layer composite and/or of the heating film composite, in particular the first composite, and/or between the at least one carrier film and a substrate and/or between the first carrier film and the second carrier film.

The first carrier film is or has been preferably arranged further to the front side and/or closer to the visible side than the second carrier film. The first decorative ply is or has been preferably arranged further to the front side and/or closer to the visible side than the second decorative ply. The second decorative ply is preferably disposed on a reverse side, proceeding from the at least one carrier film. In particular, the second decorative ply does not necessarily presuppose the first decorative ply.

What is meant in particular by “has penetrated” or “penetrating” is in particular that the layer or component into which the at least one heating wire and/or the multicore heating conduit has penetrated or penetrates, in particular as a result of the application process, has elevations and recesses, where the at least one heating wire and/or the multicore heating conduit is or has been positioned in one or more of the recesses. Preferably, the at least one heating wire and/or the multicore heating conduit is at least partly enclosed by elevations adjacent to the one or more recesses. It is also possible that the at least one heating wire and/or the multicore heating conduit is fully enclosed by a layer into which it has penetrated. It is also possible that the at least one heating wire and/or the multicore heating conduit is fully enclosed only in selected regions by a layer into which it has penetrated as a result of the application process, and in the other regions is not fully enclosed by a layer that it has partly penetrated as a result of the application process.

It is possible that the heating wire is or has been inserted into the at least one carrier film, in particular into the first carrier film or into the second carrier film and/or into the at least one decorative ply, in particular into the first and/or second decorative ply and/or into the layer composite and/or into the heating film composite, in particular the first composite, with a penetration depth within a range from 20% to 100%, in particular 50% to 80%, of its thickness, in particular its minimum width and/or its diameter. It is also possible that the multicore heating conduit is or has been inserted into the at least one carrier film, in particular into the first carrier film or into the second carrier film and/or into the at least one decorative ply, in particular into the first and/or second decorative ply and/or into the layer composite and/or into the heating film composite, in particular the first composite, with a penetration depth within a range from 20% to 100%, in particular 50% to 80%, of its thickness, in particular its minimum width and/or minimum height and/or its diameter. A penetration depth can preferably be measured in cross section, preferably in a plane with the direction of extension of the heating wire and/or of the multicore heating conduit as normal to this plane. By comparing the depth of elevations and depressions of layers adjacent to the heating wire and/or the multicore heating conduit with the width of the heating wire and/or the multicore heating conduit, the penetration depth is preferably measured in the same direction as the surface normal of the element in which the heating wire and/or the multicore heating conduit is/has been inserted.

It is also possible that the at least one heating wire and/or the multicore heating conduit is or has been inserted into one or more adhesive layers possessed by the at least one carrier film, in particular the first and/or second carrier film, in particular a first adhesive layer or a second adhesive layer. It is possible in particular that the at least one carrier film has or has been provided with a first adhesive layer to which in particular the at least one heating wire and/or the multicore heating conduit is or has been applied and/or into which the at least one heating wire and/or the multicore heating conduit is or has been inserted. The first adhesive layer is preferably disposed on a front side or a reverse side of the at least one carrier film.

It is preferable that, before step a) and/or for bonding in step iv) and/or step IV), penetration of the heating wire and/or the multicore heating conduit by ultrasound is conducted, in particular with a frequency within a range from 20 kHz to 150 kHz, preferably from 50 KHz to 100 kHz, where lower ultrasonic frequencies are typically associated with higher amplitude and higher ultrasonic frequencies with lower amplitude. The ultrasound is preferably generated by means of one or more sonotrodes, and the at least one heating wire and/or the multicore heating conduit is in particular applied to the one or more sonotrodes, but preferably guided through the corresponding sonotrode in the process, in particular in order to allow easier guiding around curves and the like. The layer into which the heating wire and/or the multicore heating conduit is to penetrate and the at least one heating wire and/or the multicore heating conduit are preferably arranged next to one another. In particular, the ultrasound increases the fluidity of the layer into which the heating wire and/or the multicore heating conduit is to penetrate such that the penetration of the at least one heating wire and/or the multicore heating conduit takes place via the application pressure that exists, in that the at least one heating wire and/or the multicore heating conduit displaces material in this layer. The ultrasound, owing to friction on contact regions with the at least one heating wire and/or with the multicore heating conduit, preferably causes a local energy input accompanied by local melting of this layer.

The at least one heating wire and/or the multicore heating conduit is preferably conducted through the sonotrode or led to the sonotrode, where the sonotrode vibrates and/or oscillates with ultrasound, for example at 70 kHz. Preferably, by means of the sonotrode, in particular by means of a mouthpiece of the sonotrode, the at least one heating wire and/or the multicore heating conduit is mounted on the surface of the at least one carrier film, preferably mounted gradually, and inserted into the surface, preferably inserted gradually. This is done in particular in that the surface and/or an insulation of the at least one heating wire and/or at least one outer layer, in particular at least one baking varnish layer, of one or more outer layers is melted locally as a result of the ultrasound at the site of the sonotrode, in particular of the mouthpiece, and the surface is preferably bonded to the insulation and/or the at least one outer layer. At the same time, the sonotrode is preferably moved according to a path that follows the ultimate shape of the at least one heating wire and/or the multicore heating conduit. In this context, but also independently thereof, an advantageous version may be one in which the at least one heating wire and/or the multicore heating conduit in the heating film composite, in the layer composite and/or in the film body is or has been arranged in an arrangement which is curved, preferably loop-shaped, at least in some regions and/or is or has been arranged in an arrangement which is curved, preferably loop-shaped, at least in some regions on a flat or curved surface of the at least one carrier film. In particular, the at least one heating wire and/or the multicore heating conduit, preferably in the heating film composite, in the layer composite and/or in the film body, i.e. in a Cartesian coordinate system, has curvature in all three spatial directions. The sonotrode is appropriately movable and/or rotatable in one or more spatial directions. The sonotrode is preferably moved by means of a robot arm, preferably moved automatically, and/or is movable thereby. Alternatively or additionally, it is possible that the at least one carrier film in the production of the layer composite and/or of the heating film composite is positioned on a table that is movable and/or rotatable in one or more spatial directions. An advantage is in particular that complex surfaces can be reliably and efficiently provided with the at least one heating wire and/or the multicore heating conduit.

Moreover, a feeding device for applying the at least one heating wire and/or the multicore heating conduit including the sonotrode and a supply unit, in particular a supply roll, for providing the at least one heating wire and/or the multicore heating conduit may be provided, where the supply unit, preferably including the sonotrode, is in a movable arrangement and/or is moved. The at least one heating wire and/or the multicore heating conduit is advantageously guided from the supply unit to the sonotrode and/or through the sonotrode, for example by unrolling from the supply roll.

After the at least one heating wire and/or the multicore heating conduit has been applied by means of the sonotrode, it is possible in particular that the following step is conducted: severing, in particular automatically severing, the at least one heating wire and/or the at least one heating conduit. The severing is preferably followed by removal of the feeding device and/or the sonotrode from the at least one carrier film with the at least one heating wire and/or the multicore heating conduit.

The at least one heating wire is preferably opaque, especially to visible light, preferably to wavelengths in a range from 380 nm to 780 nm. The one or more further heating wires are preferably opaque, especially to visible light, preferably to wavelengths in a range from 380 nm to 780 nm. It is possible that the at least one heating wire and/or the multicore heating conduit is visible from the visible side of the film body, in particular visible by the human eye, preferably by the naked human eye. It is possible that the shaping of the at least one heating wire is logically linked to a motif formed by the at least one decorative ply. It is also possible that the at least one heating wire and/or the multicore heating conduit is invisible from the visible side of the film body, in particular invisible to the human eye, preferably to the naked human eye.

It is possible that the at least one heating wire and/or the multicore heating conduit, in particular when viewed perpendicular to a plane formed by the layer composite and/or the at least one carrier film, has one or more of the following forms: spiral track, loop track, jagged tracks, oscillating tracks with constant or changing amplitude, U-shaped tracks, straight tracks that are preferably connected by curved tracks, for example with each or every second curve track having the same sign of curvature, successive, preferably straight, paths that are preferably connected by vertices.

The at least one heating wire and/or the multicore heating conduit appropriately at least partly overlaps with a radiation region, where the radiation region is or has been envisaged in particular for irradiation with electromagnetic radiation from a radiation source encompassed by the film body or connected or connectable to the film body. The radiation from the radiation source can be reflected at least partly by a reflection layer, for example, prior to irradiation.

The radiation region may also be larger than the region actually irradiated. In particular, the radiation region, when viewed perpendicular to a plane formed by the layer composite and/or the heating film composite, in particular the first composite, and/or the at least one carrier film, or when viewing the visible side of the film body, may be fully within the layer composite and/or the heating film composite, in particular the first composite, and/or within the film body, or partly within the layer composite and/or the heating film composite, in particular the first composite, and/or within the film body.

The film body preferably is or has been bonded to a radiation source, in particular a measuring device, preferably a radar device, for example for distance measurement, and/or a light source, for example for formation of a headlight and/or for formation of backlighting of the at least one decorative ply which is provided particularly in addition to a headlight function. Advantageously, in spite of the at least one decorative ply and the at least one heating wire and/or the multicore heating conduit, it is possible to achieve sufficient overall transparency of the film body, in particular the cover element. The influence of the heating wire and/or the multicore heating conduit on measured values from a measuring device optionally provided with the film body is preferably negligible and/or can be taken into account, for example, by adjusting the processing of measured data by means of training data and/or in the design of the heating coils and the surface occupancy of the heating wires for provision of the heating, taking account of required electrical resistances of the heating wires. The effect achieved is in particular that the heating is designed such that the heating output in the component is sufficiently high that the regions for penetration of the radiation are ice-free or deicable and are additionally designed in particular such that transmission of the respective radiation is maximized or absorption thereof is minimized.

It is possible that the at least one heating wire and/or the multicore heating conduit, in particular when viewed perpendicular to a plane formed by the heating film composite, in particular the first composite, the layer composite and/or the at least one carrier film, preferably the first carrier film, covers an area within a range from 0.1% to 50%, preferably within a range from 1% to 10%, more preferably within a range from 1% to 5%, where the occupied area is the area of the region of the heating film composite, in particular of the first composite, and/or of the layer composite, in particular of the at least one carrier film, preferably of the first carrier film, that overlaps with the at least one heating wire and/or with the multicore heating conduit, divided by the total area of the heating film composite and/or layer composite, in particular the first carrier film. Such an area coverage can advantageously provide a particularly strong heat output, in particular where the at least one heating wire can be rendered visible and, for example, good integration thereof into a design is possible. In this context, it is preferably possible for the area coverage of the heating wire and/or the multicore heating conduit over the surface of the cover element not to be homogeneous but inhomogeneous, by means of which it is possible in particular to form regions having a higher heating output, and also lower heating output.

It is also possible that a plurality of heating wires having one or more features that have been described for the at least one heating wire are or have been provided.

The heating film composite, in particular first composite, and/or the layer composite preferably has a length and/or width within a range from 3 cm to 350 cm and/or an area within a range from 5 cm² to 60 000 cm², in particular when viewed perpendicular to a plane formed by the heating film composite and/or the layer composite and/or the at least one carrier film, preferably in top view. Preferably, the heating film composite and/or the layer composite has a thickness within a range from 0.1 cm to 10 cm, preferably within a range from 0.2 cm to 5 cm. The film body preferably has a length and/or width within a range from 3 cm to 350 cm and/or an area within a range from 5 cm² to 60 000 cm², in particular when viewed perpendicular to a plane formed by the film body, preferably in top view. Preferably, the film body has a thickness within a range from 0.1 cm to 10 cm, preferably within a range from 0.2 cm to 5 cm.

It is possible that the at least one heating wire and/or the multicore heating conduit, in particular when viewed perpendicular to a plane formed by the layer composite and/or the heating film composite, in particular the first composite, and/or the at least one carrier film, covers an area within a range from 0.1% to 50%, preferably within a range from 1% to 10%, more preferably within a range from 1% to 5%. The area covered is in particular the area of the region of the layer composite and/or of the heating film composite, in particular of the first composite, and/or of the at least one carrier film, that overlaps with the at least one heating wire and/or the multicore heating film composite, divided by the total area of the layer composite and/or of the heating film composite, in particular of the first composite, and/or of the at least one carrier film.

In particular, it is possible that the at least one carrier film, which is provided with the at least one heating wire and/or the multicore heating conduit, and/or the heating film composite and/or the layer composite has the following illustrative properties:
width of 100 cm,
length of 100 cm,
area 10 000 cm²,
distance d, preferably minimum distance d, between opposite, in particular parallel, conductor tracks of the at least one heating wire: 0.5 cm
number of mutually opposite, in particular parallel, conductor tracks of the at least one heating wire: 200, amounting to preferably 10 000 cm²
distance of the at least one heating wire from opposite ends of the layer composite: 1 cm.
length of the at least one heating wire: 19 600 cm,
diameter of the at least one heating wire: 100 μm,
area covered: 196 cm² (=length of the at least one heating wire x diameter of the at least one heating wire).
area coverage of the at least one heating wire: 1.96% (=percentage of the area occupied by the at least one heating wire in relation to the total area).

The total area can thus be determined in particular from the product of the width and length of the layer composite and/or the at least one carrier film.

It is possible that step c) includes one or more of the following steps:
c1) overmolding the at least one carrier film, in particular the layer composite and/or the heating film composite, in particular the first composite, with the second free-flowing composition in the form of a plastic injection molding material to obtain the second carrier component,
c2) flow coating the at least one carrier film, in particular the layer composite and/or the heating film composite, in particular the first composite, with the second free-flowing composition which preferably comprises or consists of polyurethane (PUR) to obtain the second carrier component,
c3) painting the at least one carrier film, in particular the layer composite and/or the heating film composite, in particular the first composite, with the second free-flowing composition to obtain a protective varnish layer.

It is also possible that step c3) is conducted after step c1) and/or after step c2) as follows:
c3) painting the at least one carrier film, in particular the layer composite and/or the heating film composite, in particular the first composite, with a third free-flowing composition to obtain a protective varnish layer.

It is possible that step c3) is conducted by wet painting, preferably by spraying or flow coating or dipping.

The second and/or third free-flowing composition applied to the at least one carrier film in step c1), c2) and/or c3) may be or have been applied in particular directly or indirectly.

It is possible that the first and/or second and/or third free-flowing composition and/or the first carrier component, the second carrier component and/or the protective varnish layer comprises or consists of a 2K varnish.

A 2K varnish is especially a two-component varnish. It is possible that the first and/or second and/or third free-flowing composition and/or the first carrier component, the second carrier component and/or the protective varnish layer comprises or consists of one or more of the following materials: polymethylmethacrylate (PMMA), polyvinylchloride (PVC), melamine, acrylates. The first and/or second and/or third free-flowing composition which comprises or consists of a 2K varnish is preferably free of polymers and/or free of thermoplastic polyurethane (TPU). The second carrier component produced in particular by step c2) and/or c3), and/or the protective varnish layer produced in particular by step c3), comprises or preferably consists of a thermoset and/or is free of thermoplastic.

It is also possible that the first and/or second and/or third free-flowing composition includes or consists of a radiation-curing varnish, preferably radiation-curing dual cure varnish. In particular, the first and/or second carrier component and/or the protective varnish layer is or has been produced from a radiation-curing varnish, preferably radiation-curing dual cure varnish. In particular, the radiation-curing varnish, preferably radiation-curing dual cure varnish, is or has been thermally precrosslinked in a first step on and/or after application in liquid form. Preferably, in a second step, in particular after the processing of the heating film composite and/or the layer composite, the radiation-curing varnish, preferably radiation-curing dual cure varnish, is free-radically postcrosslinked, in particular via high-energy radiation, preferably UV radiation. Dual cure coatings of this type may comprise or consist of various polymers or oligomers having unsaturated acrylate or methacrylate groups. These functional groups may be free-radically crosslinked with one another, especially in the second step. For thermal precrosslinking in the first step, it is particularly advantageous that at least two or more alcohol groups are also present in these polymers or oligomers. These alcohol groups may be crosslinked with multifunctional isocyanates or melamine-formaldehyde resins. Useful unsaturated oligomers or polymers preferably include various UV raw materials such as epoxy acrylates, polyether acrylates, polyester acrylates and in particular acrylate acrylates. Useful isocyanates include both blocked and unblocked representatives on TDI (TDI=toluene 2,4-diisocyanate), HDI (HDI=hexamethylene diisocyanate) or IPDI (IPDI=isophorone diisocyanate). The melamine crosslinkers may be fully etherified versions, may be imino types, or are benzoguanamine representatives.

The protective varnish layer preferably has a layer thickness within a range from 5 μm to 20 μm.

The protective varnish layer may be formed alternatively or additionally to the second carrier component, and in particular may be or may have been positioned on the front side of the heating film composite, in particular first composite, and/or of the layer composite and/or on the visible side of the second carrier component. For formation of the protective varnish layer, the heating film composite and/or layer composite, in particular with the first carrier component and optionally the second carrier component, is removed from the cavity beforehand, in order, for example, to position it in a second cavity, in particular in an exactly fitting manner, and to apply the protective varnish layer, preferably to the layer composite.

The in-mold flow coating in step b) and/or the flow coating in step c2) is in particular a flow coating operation. In the in-mold flow coating in step b) and/or the flow coating in step c2), the first and/or second free-flowing composition is preferably formed by a flow coating composition. The flow coating composition is preferably fed into a cavity at a pressure of not more than 10 bar and/or at a temperature within a range from 30° C. to 100° C. The flow coating composition preferably comprises or consists of one or more materials selected from: PUR, PUR derivatives.

The first carrier component preferably has a layer thickness within a range from 50 μm to 2000 μm.

The overmolding in step c1) is in particular an injection molding operation, wherein the second free-flowing composition is a plastic injection molding material. The second carrier component obtained is preferably transparent, further preferably crystal clear.

The in-mold coating in step b) is in particular an injection molding operation. The first free-flowing composition for in-mold coating is preferably a plastic injection molding material.

In injection molding, the plastic injection molding material is preferably injected into a cavity at a pressure in the range from 100 bar to 2000 bar and/or at a temperature within a range from 100° C. to 350° C., in which, in particular, the heating film composite and/or the layer composite is inserted and preferably one or more closed clearances are formed adjacent to the layer composite, into which the plastic injection molding material is injected.

A plastic injection molding material preferably comprises or consists of one or more of the following materials: thermoplastic, in particular polyurethane, thermoset or a mixture. Suitable plastic injection molding materials are preferably selected from the group consisting of acrylonitrile-butadiene-styrene copolymers (abbreviation: ABS), polycarbonate (abbreviation: PC), a mixture of ABS and PC, polyoxymethylene (abbreviation: POM), polymethylmethacrylate (abbreviation: PMMA), styrene-acrylonitrile copolymers (abbreviation: SAN), acrylonitrile-styrene-acrylate copolymers (abbreviation: ASA), polypropylene (abbreviation: PP), olefin-based thermoplastic elastomers (abbreviation: TPO), polyamides (abbreviation: PA) and mixtures of at least two materials from this group that are compatible with one another.

For performance of step b), in particular for performance of the in-mold coating, and/or step c1), in particular for performance of the overmolding, the heating film composite, in particular the first composite, and/or the layer composite and/or in particular the at least one carrier film which has been provided with the at least one heating wire and/or the multicore heating conduit is or has been preferably inserted into a cavity, preferably formed by at least two mold shapes, in particular from the first and second mold shapes of the apparatus of the invention. The cavity is formed in particular by preferably closing the at least two mold shapes. Subsequently, the first carrier component is preferably formed by in-mold coating of the heating film composite and/or the layer composite and/or the at least one carrier film that has been provided with the at least one heating wire and/or the multicore heating conduit with the first free-flowing composition, where the first free-flowing composition assumes a shape that follows the cavity and is cured to give the first carrier component, and/or the second carrier component is preferably formed by overmolding of the heating film composite and/or layer composite and/or the at least one carrier film that has been provided with the at least one heating wire and/or the multicore heating conduit with the second free-flowing composition, where the second free-flowing composition assumes a shape that follows the cavity and is cured to give the second carrier component. For this purpose, in particular before the in-mold coating or overmolding, a first clearance adjoining the heating film composite and/or layer composite and/or adjoining the at least one carrier film that has been provided with the at least one heating wire and/or the multicore heating conduit is formed by the cavity, in order to form the first carrier component, and/or a second clearance adjoining the heating film composite and/or layer composite and/or the at least one carrier film that has been provided with the at least one heating wire and/or the multicore heating conduit is formed by the cavity and/or another cavity which is preferably formed by an alternation of at least one mold shape of the at least two mold shapes, in order to form the second carrier component.

The first and second clearance are or have been positioned preferably on opposite sides of the heating film composite and/or layer composite and/or of the at least one carrier film that has been provided with the at least one heating wire and/or the multicore heating conduit, and/or the in-mold coating and the overmolding is preferably conducted on two opposite sides of the heating film composite and/or layer composite and/or of the at least one carrier film that has been provided with the at least one heating wire and/or the multicore heating conduit, in particular conducted successively. For this purpose, the cavity may be adjusted between the in-mold coating and the overmolding, for example by replacing a mold shape or by rotating a mold shape. For performance of step c), the heating film composite and/or layer composite, in particular including the first carrier component, and/or the at least one carrier film that has been provided with the at least one heating wire and/or the multicore heating conduit and in particular has been provided with the first carrier component is preferably positioned in a further cavity of a further injection molding apparatus and/or a flow coating apparatus, or the further cavity is formed in the same injection molding apparatus and the further cavity is closed or a second clearance is formed in the cavity used for in-mold coating or in-mold flow coating on an opposite side of the heating film composite and/or layer composite and/or of the at least one carrier film that has been provided with the at least one heating wire and/or the multicore heating conduit from the first carrier component.

Subsequently, the second carrier component is formed by overmolding or flow coating of the layer composite and/or of the at least one carrier film that has been provided with the at least one heating wire with the second free-flowing composition, where the second carrier component assumes a shape that follows the further cavity and/or the second clearance.

It is possible that step b) and/or step iv) is an IMD (IMD=in-mold-decoration) method. Preferably, in the in-mold coating in step b), the first free-flowing composition or the first carrier component obtained therefrom is or has been bonded to the at least one carrier film that has been provided with the at least one heating wire and/or the multicore heating conduit, and/or bonded to the at least one decorative ply and/or to the layer composite and/or to the heating film composite, and hence preferably decorated in an IMD method.

It is possible that the heating film composite and/or the layer composite and/or the at least one carrier film that has been provided with the at least one heating wire and/or the multicore heating conduit is an in-mold label, and/or step b) is an IML method (IML=in-mold labeling). In this case, the at least one carrier film that has been provided with the at least one heating wire and/or the multicore heating conduit, and/or, preferably after step iv) or after step IV), the layer composite or the heating film composite is or has been obtained by a separation process, preferably punching, in particular from the layers bonded in step iv) or in step IV).

The method of producing the heating film composite or the layer composite that may preferably be included in the method of producing the film body, and/or the method of producing the film body in particular comprises one or more of the following steps, in particular in the sequence specified:
laminating and/or screen printing and/or hot stamping the at least one decorative ply onto the at least one carrier film, in particular to obtain a roll or a sheet having the at least one decorative ply and the at least one carrier layer,
punching the at least one carrier film with the at least one decorative ply, in particular the roll or the sheet, preferably to obtain an in-mold label,
placing the at least one heating wire and/or the multicore heating conduit onto the at least one carrier film with the at least one decorative ply, in particular to obtain the layer composite,
placing the layer composite into an injection mold,
performing step b), in particular in-mold coating of the layer composite with the first free-flowing composition which is a thermoplastic composition,
performing step c), in particular flow coating the layer composite with the second free-flowing composition which preferably comprises or consists of PUR, and optionally overpainting the layer composite and/or the second carrier component with the third free-flowing composition to obtain a protective varnish layer,
installing in a vehicle, in particular as exterior trim or interior trim,
establishing contact between the heating element and the corresponding power supply to the vehicle, in particular via the contacting element.

It is possible that the placing of the at least one heating wire and/or the multicore heating conduit is conducted before or after punching, where the punching affords the layer composite.

It is also possible that the heating film composite and/or the layer composite is formed, in particular by means of an HPF process (HPF=high-pressure forming). In particular, the heating film composite and/or the layer composite is formed at high pressure and low temperature, in particular a pressure within a range from 80 bar to 120 bar at a temperature within a range from 80° C. to 150° C. The forming can be conducted in particular after step iv) and/or before step b).

It is also possible to supply the heating film composite and/or the layer composite as an insert element to an injection molding process, by means of which the film body is obtainable, as described in particular for the method of producing a film body.

The at least one carrier film preferably comprises or consists of polycarbonate (PC). It is also possible that the at least one carrier film is single-layer or multilayer and/or preferably comprises or consists of one or more thermoplastics, preferably in the form of an extrudate or of a coextrudate or of a triextrudate, and in particular comprises or consists of one or more of the following materials: PC, acrylonitrile-butadiene-styrene copolymer (ABS), polymethylmethacrylate (PMMA), polypropylene (PP). Coextrudates or triextrudates may in particular comprise several layers of the same materials or several layers of different materials.

The at least one heating wire and/or the multicore heating conduit is or has been preferably inserted directly into such a carrier film and/or inserted into an adhesive layer of such a carrier film.

Preferably, the at least one carrier film, in particular in the heating film composite and/or in the layer composite and/or in the film body, is transparent, further preferably crystal clear, preferably to wavelengths of light that are visible to the human eye. The layer thickness of the carrier film, in particular of the at least one carrier film comprising or consisting of PC, is in particular within a range from 50 μm to 2000 μm, preferably at 375 μm. The at least one carrier film, in particular the first carrier film and/or the second carrier film, is preferably continuous and/or hole-free, in particular over the full area and/or at least in one or more regions occupied by the at least one heating wire and/or the multicore heating conduit, and further preferably outside a contacting element and/or outside a contact region and/or outside a contact site, for example a region with a solder site, for contacting of the at least one heating wire and/or the multicore heating conduit.

It is also possible that the at least one carrier film and/or the layer composite and/or the heating film composite, in particular the first composite, includes a first carrier film and a second carrier film, both preferably consisting of or comprising PC. Between the first carrier film, preferably one or more of the following components are present: the at least one heating wire, a substrate with a reflection layer, the at least one decorative layer, in particular a first decorative layer and/or a second decorative layer.

The front side of the film body and/or, for example, at least the materials of the layers that are or have been arranged proceeding from the visible side up to the at least one heating wire, up to the at least one decorative layer and/or up to the at least one carrier film are preferably transparent and/or not opaque, in particular to visible light. In particular, the at least one heating wire and/or the at least one decorative ply and/or the multicore heating conduit is thus visible from the visible side of the film body.

It is possible that the at least one heating wire and/or the multicore heating conduit, in particular in the method of producing the film body and in the film body produced, is or has been positioned directly adjacent to the second carrier component or to the protective varnish layer. For this purpose, it is possible that the second and/or third free-flowing composition has been brought into direct contact with the at least one heating wire and/or the multicore heating conduit.

It is possible that a first side of the at least one carrier film is or has been provided with at least one first decorative ply and the at least one heating wire and/or the multicore heating conduit, and that a second side opposite the first side is or has been provided with at least one further decorative ply, in particular the second decorative ply. In particular, the first side may constitute either the front side or the reverse side of the at least one carrier film. The first decorative ply preferably does not automatically presuppose the second decorative ply. However, it is possible that both are present.

It is also possible that the at least one heating wire and/or the multicore heating conduit, preferably comprising at least one of the at least one decorative ply, further preferably comprising the first and/or the second decorative ply, is or has been positioned between two carrier films, in particular the first carrier film and the second carrier film of the at least one carrier film.

It is possible that the at least one decorative ply and/or one or more further layers are or have been positioned in the heating film composite and/or in the layer composite and/or in the film body. In particular, one or more of the at least one decorative ply and/or the one or more further layers are or have been formed as an intermediate layer, an adhesion layer and/or as a dirt-repellent layer.

One or more of the at least one decorative ply and/or the further layers may be applied in particular by means of one of the following methods: physical vapor deposition (PVD), in particular evaporation and/or sputtering, preferably by means of organic evaporation and/or magnetron sputtering, chemical vapor deposition (CVD), in particular parylene deposition. A layer comprising or consisting of parylene may preferably be or have been used for the dirt-repellent function of a layer.

In particular, it is possible that one or more of the at least one decorative ply and/or one or more further layers are or have been positioned between two or more layers of the heating film composite and/or the layer composite and/or the film body. It is preferably possible that one or more of the at least one decorative ply and/or one or more further layers are or have been positioned as an outermost layer of the heating film composite and/or the layer composite and/or the film body and/or are or have been positioned between the heating film composite or the layer composite and the first free-flowing composition or the first carrier component, between the heating film composite or the layer composite and the second free-flowing composition or the second carrier component or the protective varnish layer.

Preferably, the film body, in particular the film body obtained by the method, has a visible side and a reverse side. The visible side may be considered to mean, in particular, the side facing the viewer of the film body in the intended use.

The at least one carrier film in particular has a reverse side and a front side, preferably where the visible side of the film body is formable, has been formed or is formed at least on the front side, and/or the reverse side of the film body is formable, has been formed or is formed on the reverse side of the at least one carrier film. The at least one heating wire and/or the multicore heating conduit is or has been preferably applied to a front side or the reverse side of the at least one carrier film. It is also possible that the at least one decorative ply comprises several decorative plies, in particular where one or more decorative plies are or have been positioned on the front side and/or one or more decorative plies on the reverse side. The at least one heating wire and/or the multicore heating conduit is preferably applied to one side of the at least one carrier film with or without a decorative ply. In particular, the at least one heating wire and/or the multicore heating conduit merely forms a ply and/or merely a preferably coherent heating wire structure and/or a preferably coherent heating conduit structure and/or is positioned on only one side, for example only the front side or the reverse side of the heating film composite and/or the layer composite.

Preferably, the at least one carrier film and/or the layer composite and/or the heating film composite, in particular the first composite, and/or in particular the film body comprises a substrate which preferably has a reflection layer. It is possible that the at least one carrier film comprises a first carrier film and a second carrier film, wherein the substrate comprising at least one reflection layer is or has been arranged between the first carrier film and the second carrier film, and in particular wherein the at least one heating wire and/or the multicore heating conduit is or has been arranged between the first carrier film and the substrate or between the second carrier film and the substrate. Preferably, the reflection layer includes a material which, together with at least one adjacent layer, in particular selected from the at least one carrier film, preferably the first carrier film and/or the second carrier film, and/or an adhesive layer on the at least one carrier film, preferably on the first carrier film and/or on the second carrier film, and/or the material comprising this/these layer(s) in the finished film body, forms an optical interface, preferably such that there is a difference in the refraction index of materials at the interface. A reflection thus takes place at this optical interface. This optical interface is then in particular at least partly reflective, i.e. in particular in that a fraction of laterally incident light, in particular light laterally incident at least into the first carrier component, is reflected at the interface and another fraction is transmitted, in particular in the direction of the at least one decorative ply and of the at least one heating wire and/or the multicore heating conduit. Thus, light incident into the film body in particular, in particular into at least the first carrier component, is partly trapped in the layer structure in order to enable, in particular, at least weak backlighting of the at least one decorative ply.

The film body, in particular the film body having the above-described reflection layer, is or has been preferably provided with a light source for incidence of light, in particular into at least the first carrier component. The light source is in particular mounted laterally, preferably on a side that does not form the reverse side and/or front side of the film body.

It is also possible that one or more decorative plies of the at least one decorative ply are or have been positioned between the first carrier film and the substrate and/or between the second carrier film and the substrate. Preferably, the least one heating wire and/or the multicore heating conduit and the at least one decorative ply are or have been positioned on a visible side of the substrate, in particular positioned collectively on a visible side of the substrate. The visible side of the substrate is in particular visible in the film body and/or facing the visible side of the film body.

The substrate is preferably multilayered. The reflection layer comprises or preferably consists of PMMA. It is possible that the reflection layer is provided as a film insert, in particular as a sheet or else as roll material. Preferably, the substrate has one or more adhesive layers on the reflection layer, in particular an adhesive layer on each side. The at least one heating wire and/or the multicore heating conduit is or has been preferably applied to or inserted into one of the adhesive layers. The heating film composite and/or the layer composite is or has been also preferably provided with a first carrier film, in particular on the visible side, and a second carrier film, in particular on the reverse side, which in particular form outer surfaces of the heating film composite and/or the layer composite and/or comprise or consist of PC. In steps b) and c), the first carrier film is preferably bonded directly to the second carrier component and/or the protective varnish layer and the second carrier film is preferably bonded directly to the first carrier component. It is thus advantageously possible to achieve a particularly stable bond of the heating film composite and/or the layer composite to the carrier components or the protective varnish layer in the film body. It is optionally possible that one or more further adhesive layers are or have been positioned on the first and/or second carrier film.

It is possible that the film body is or has been provided with at least one light guide layer. In the light guide layer, light at least partly reflected by the reflection layer can be incident, as already described above in particular. The light guide layer preferably comprises one or more of the following materials: PC, PC derivatives, modified PC. The at least one light guide layer may in particular be the first carrier component. In particular, the reflection layer comprises one or more of the following materials: PMMA, PMMA derivatives, modified PMMA. The reflection layer is or has been preferably applied with a layer thickness within a range from 2 μm to 200 μm, in particular 50 μm. The reflection layer is or has been preferably brought into contact with a radiation source, in particular an LED radiation source, and/or is or has been configured to be bondable thereto.

Thus, the film body produced may in particular be a headlight having a cover element which is transmissive in particular to light with wavelengths within a range from 380 nm to 780 nm, having a heatable surface.

A material that may be or may have been used for the one or more adhesive layers and/or the one or more further adhesive layers is one or a combination of the following adhesive groups: solventborne adhesives, dispersion adhesives, contact adhesives, plastisols, hotmelt adhesives, chemically curing adhesives.

The at least one decorative ply is or has been preferably applied to the at least one carrier film, in particular the first carrier film and/or the second carrier film.

The at least one first decorative ply is or has been preferably applied to the front side and/or the reverse side of the carrier film. The at least one heating wire and/or the multicore heating conduit and the at least one decorative ply are or have been preferably applied on the same side of the carrier film and/or on opposite sides of the carrier film. The at least one decorative ply preferably comprises at least a first decorative ply and/or in particular at least a second decorative ply. In particular, it is possible that the first decorative ply and/or the second decorative ply is or has been applied to the front side or reverse side of the carrier film. In particular, it is possible that the first decorative ply is or has been applied on the front side of the at least one carrier film and the second decorative ply on the reverse side of the carrier film. It is also possible that the first decorative ply is or has been applied on the reverse side of the carrier film and the second decorative ply on the front side of the carrier film.

Preferably, one or more decorative plies of the at least one decorative ply, in particular the first and/or the second decorative ply, are preferably applied in motif form and/or over the full area. What is meant by a motif or in motif form is, for example, one or more shapes selected individually or in combination from geometric shape, guilloche, infinite pattern, image, symbol, logo, coat of arms, portrait, alphanumeric characters, QR code, barcode. A motif may be or have been formed as a single image and/or as an infinite pattern.

It is possible that one or more decorative plies of the at least one decorative ply, in particular the first and/or the second decorative ply, are or have been applied by one or more of the following methods: hot stamping, cold stamping, gravure printing, screen printing, inkjet printing, flexographic printing, digital printing, offset printing.

One or more of the at least one decorative ply, in particular the first and/or second decorative ply, are selected in particular from one or more of the following layers or layer structures: decorative ply with infinite pattern, decorative ply with single image, partial decorative ply, full-area decorative ply, decorative ply on only one side, in particular the reverse side or the front side of the first carrier film, decorative ply on both sides, in particular the reverse side and the front side of the first carrier film, decorative ply comprising or consisting of metal, decorative ply with one or more preferably partial surface reliefs, decorative ply with a full-area surface relief, reflection layer, in particular metal layer or HRI layer (HRI=high refractive index), replication layer, color varnish layer, in particular full-tone color varnish layer and/or half-tone color varnish layer, preferably color varnish layer with a print raster.

Advantageously, because the multicore heating conduit and optionally the at least one decorative ply and/or the at least one decorative ply and the at least one heating wire are or have been first provided on the carrier film in the heating film composite and/or in the layer composite, and then the heating film composite and/or the layer composite is coated or encased with free-flowing materials on both sides, it is possible to achieve a film body with improved heat conduction since, for example, trapped air is avoided.

The second carrier component positioned on the visible side forms or is used to form a lens, for example, preferably of a headlight. The second carrier component may form the cover element, in particular of a headlight, or be encompassed by a cover element. The first carrier component positioned on the reverse side forms or is used to form, for example, a contact surface or a holder for a radiation source and/or for installation of the film body.

The at least one decorative ply preferably includes at least one indium layer comprising or consisting of indium. The indium layer is or has been preferably vapor-deposited. The indium layer is advantageously transparent to electromagnetic radiation, in particular to wavelengths in a range from 1 GHz to 150 GHz for radar applications and/or within a range from 350 THz to 850 THz for visible light. The indium layer is advantageously reflective to the human eye, in particular wavelengths within a range from 380 nm to 780 nm. Preferably, the indium layer, in particular on vapor deposition, forms islands which preferably cause the aforementioned effects.

The bonding in step iv) preferably includes a hot stamping operation. Preferably, one or more decorative plies of the at least one decorative ply are applied as a transfer ply, preferably of a hot stamping film, preferably to the at least one carrier film, in particular the first and/or second carrier film. A hot stamping film in particular includes the transfer ply, positioned on a carrier layer so as to be removable. A release layer may be provided between the transfer ply and the carrier layer.

In particular, a transfer ply has one or more of the following layers:
one or more release layers, preferably having a layer thickness within a range from 0.01 μm to 10 μm, preferably from 1 μm to 2 μm. One or more release layers of these release layers can be removed after the transfer of the transfer ply, in particular to the at least one carrier film, or remain thereon and serve as protective layer or as adhesion promoter.
one or more protective layers, preferably having a layer thickness within a range from 0.1 μm to 50 μm, preferably from 1.5 μm to 35 μm. One or more protective layers of these protective layers, in particular when the transfer ply is transferred to the at least one carrier film, may protect further transfer ply layers and optionally also serve as an adhesion promoter, for example, in the layer composite.
one or more decorative layers, preferably having a layer thickness within a range from 0.2 μm to 20 μm, preferably from 1.5 μm to 7 μm. Such decorative layers may be, for example, a print layer produced by printing on the transfer ply, or layers that are or have been applied, for example, by a hot or cold stamping process.
one or more vapor-deposited layers, preferably having a layer thickness within a range from 5 nm to 200 nm, preferably up to 30 nm.
one or more primer layers, preferably having a layer thickness within a range from 0.5 μm to 10 μm, preferably from 0.8 μm to 5 μm. One or more primer layers may enable sufficient adhesion of the at least one decorative ply to the at least one carrier film when the transfer ply is transferred to the at least one carrier film.

The decorative ply is provided, for example, as a removable transfer ply of a hot stamping film. In particular, the hot stamping film is brought into contact with the first carrier film and the transfer ply is transferred to the first carrier film by means of a heated stamping tool. For this purpose, the transfer ply may include a hotmelt adhesive layer, for example. The transfer may be over the full area or in the form of a motif. For this purpose, the embossing tool may, for example, have a full-area or motif-shaped embossing surface. The embossing surface may be smooth and flat or may have a surface relief structure. For example, the surface relief structure may be a matte structure.

It is possible that bonding of the at least one decorative ply, in particular with the at least one carrier film, preferably with the first and/or the second carrier film, and/or further layers is accomplished in that one or more adhesion layers are or have been applied. These adhesion layers may already be included a transfer ply or may be applied separately.

It is also conceivable that a hot stamping film as described above is used as an IMD film, for example in step b).

It is also possible that one or more decorative layers of the at least one decorative ply are a print layer, preferably a print varnish layer, and/or are printed on. The bonding may in particular include one or more of the following steps for applying one or more decorative plies of the at least one decorative ply: gravure printing, screen printing, inkjet printing, flexographic printing, digital printing, offset printing. In this case, these one or more decorative layers may be or have been applied over the full area and/or in the form of motifs. It is possible that the print application has already been done for production of a transfer ply and/or, for example, has been done onto the at least one carrier film.

It is possible that the at least one decorative ply is or has been applied for full-area or partial lamination, i.e. in particular a concealment of the at least one heating wire and/or the multicore heating conduit, in particular on viewing of the visible side of the film body and/or the front side of the layer composite and/or the heating film composite.

It is also possible that the at least one decorative ply is or has been applied such that the at least one heating wire and/or the multicore heating conduit together with the at least one decorative ply forms a decoration, for example in that the at least one heating wire and/or the multicore heating conduit continues one or more lines provided by the at least one decorative ply and/or takes up motifs and/or constitutes a partial design element and/or a partial design element is or has been explicitly highlighted by the intrinsic color and/or a partial design element highlights the technical aspect of the overall component. For example, it is possible that the decorative ply includes or is formed by what is called a “black plano” varnish. It is conceivable that the at least one heating wire and/or the multicore heating conduit is colored, in particular red. What is meant in particular by a “black plano” varnish is especially a high-gloss, deep black varnish. This varnish preferably has a very thick clearcoat layer above a black varnish layer, by means of which a depth effect is or has been preferably created.

It is also possible that the at least one heating wire and/or the multicore heating conduit has one or more outer layers. The one or more outer layers preferably each at least partly encase a heating wire or a plurality of heating wires of the at least one heating wire and/or of the one or more further heating wires. It is thus possible, for example, to provide an enlarged contact area, by means of which improved adhesion to surrounding layers in the film body is achieved. In addition, the outer layers advantageously offer an increase in optical design options, and also the possibility of generating special optical effects. In addition, it is possible that the one or more outer layers insulate, i.e. in particular mutually galvanically isolate, several heating wires or all heating wires of the multicore heating conduit. This can result in a multicore heating conduit with high flexibility, which can be transformed into complex shapes, for example, which can be particularly advantageous together with the optical effects.

One or more first outer layers of the one or more outer layers preferably have a first color. One or more second outer layers of the one or more outer layers preferably have a second color. The outer layers having the first or second color are or have been arranged in particular so as to be at least partly visible in the heating film composite, in the layer composite and/or in the film body. The first color is preferably different than the second color. This enables particularly impressive optical effects. For example, it is possible to choose the colors of the one or more outer layers such that the multicore heating conduit has a locally changing color effect. In particular, therefore, preferably in the heating film composite, in the layer composite and/or in the film body, different colors are visible at different viewing angles of the multicore heating conduit. If the multicore heating conduit has curves, there are changes and/or variations in color, for example, at least in regions according to the curvature of the multicore heating conduit, in particular when viewed at the same viewing angle, with regard to different regions of the multicore heating conduit, and/or when viewing a region of the multicore heating conduit in the event of a change from a first viewing angle to a second viewing angle. However, it is also conceivable that the one or more outer layers are of the same color.

It is additionally possible that two or more first heating wires of the at least one heating wire and of the one or more further heating wires run parallel to one another and, for example, have different-colored outer layers, in particular the first color and the second color. It is also possible that the outer layers of these first heating wires or of two or more heating wires of the first heating wires are of the same color.

Preferably, one or more heating wires of the at least one heating wire and of the one or more further heating wires, in particular the mutually parallel heating wires, in the heating film composite, in the layer composite and/or in the film body, run straight at least in sections.

It is possible, alternatively or in addition, that one or more second heating wires of the at least one heating wire and the one or more further heating wires are twisted, in particular twisted around at least one respective other heating wire of the at least one heating wire and the one or more further heating wires, for example around one or more of the first heating wires. The term “twisted” may be considered here in particular to mean tortuous, e.g. in spiral form, preferably in helical form. Different-colored outer layers of at least one twisted heating wire and a heating wire around which this twisted heating wire is twisted are conceivable, such that, for example, more complex locally changing color effects can be achieved. It is also conceivable that several heating wires are twisted around one heating wire. Preference is given to different-colored outer layers of twisted heating wires and/or uniformly colored outer layers of twisted heating wires. It is also conceivable that, in particular in the case of a multicore heating conduit in ribbon form, several mutually parallel heating wires are each connected to one another via an outer layer, in particular a baking varnish layer, of one or more twisted heating wires that extend through an intermediate space between the mutually parallel heating wires.

Preferably, in the multicore heating conduit, several outer heating wires are arranged around a central inner heating wire, in particular uniformly distributed around the inner heating wire. The outer heating wires may include one or more of the first and/or second heating wires. There are preferably four, five or six or at least four or at least five or at least six outer heating wires. It is possible that the outer heating wires and the inner heating wire have equal cross-sectional dimensions, in particular an equal diameter. It is also possible that one or more of the outer heating wires and the inner heating wire have equal cross-sectional dimensions, in particular an equal diameter.

It is possible, alternatively or additionally, that further outer heating wires are arranged around the central heating wire. Preferably, the further outer heating wires are uniformly distributed around the inner heating wire and/or the number of outer heating wires corresponds to the number of further outer heating wires. The further outer heating wires may have a greater or smaller diameter than the outer heating wires. Preferably, a heating wire of the further outer heating wires is respectively arranged between two of the outer heating wires. The further outer heating wires may comprise one or more of the first and/or second heating wires.

It is also possible that several heating wires run parallel to one another and one or more heating wires, in particular the second heating wires, are twisted around the mutually parallel heating wires.

Alternatively or additionally, it is possible that the multicore heating conduit has an axially symmetric and/or rotationally symmetric cross section and/or is in ribbon form. In particular, the axially symmetric and/or rotationally symmetric cross section has varying widths, i.e. is preferably not circular, like a single wire. What is meant in particular by “in ribbon form” is that, in cross section, a width is at least twice, preferably at least 3 times, a height of the multicore heating conduit. For example, the multicore heating conduit may be a multicore flat braid.

It is possible that at least one outer layer or all outer layers of the one or more outer layers has or have an insulation layer and/or a baking varnish layer. It is thus possible that the multicore heating conduit has one or more insulation layers and/or one or more baking varnish layers. Preferably, an insulation layer is positioned directly on a respective heating wire and/or closer to a respective heating wire than the baking varnish layer. A baking varnish layer is preferably a layer which encases the respective heating wire and/or the respective insulation layer and is preferably bondable or bonded to a matrix as a result of a thermal effect and/or in the event of a preferably subsequent thermal effect. In that case, the respective heating wire is or has been and/or the respective heating wires are or have been preferably embedded in this matrix. One or more external layers of the multicore heating conduit are preferably formed by one or more baking varnish layers.

An insulation layer in particular provides an electrical isolation of one or more heating wires of the at least one heating wire and/or of the one or more further heating wires.

What is meant in particular by a baking varnish layer is at least one layer which is bondable or bonded to a matrix as a result of and/or in the event of a thermal effect. The respective heating wire is or has been and/or the respective heating wires are or have been preferably embedded in this matrix. The one or more outer layers, in particular their insulation layers and/or their baking varnish layers, may be applied around the respective heating wire by means of a method selected individually or in combination from: dip coating, nozzle coating, spray coating, evaporation.

The one or more outer layers, in particular the one or more baking varnish layers, preferably bond the heating wires of the multicore heating conduit that have thus been encased to one another, preferably in a cohesively bonded manner. The bonding is effected in particular via contact sites and/or contact surfaces of two or more of the one or more outer layers. Such a connection preferably exists when the multicore heating conduit is applied to the at least one carrier film by means of a sonotrode. It is advantageously thus possible to conduct reliable feeding to the sonotrode and/or passage through the sonotrode of the multicore heating conduit. In addition, it is possible to secure the multicore heating conduit to the at least one carrier film by means of at least one outer layer, in particular by cohesive bonding thereto. This is done, for example, by melting using the ultrasonic sonotrode.

The multicore heating conduit in particular has one or more leveling layers. In particular, a leveling layer compensates for one or more elevations and/or depressions that are formed, for example, by the one or more outer layers. It is thus possible that the multicore heating conduit has a surface and/or outer face with a flat face and/or with a surface that has been smoothed with respect to a surface which is formed by one or more outer layers. Moreover, the stability of the multicore heating conduit can be improved.

The one or more leveling layers preferably have one or more adhesion layers which can in particular ensure improved adhesion of the multicore heating conduit, and/or one or more decorative layers which can in particular cause additional optical effects, for example depth effects and/or optically variable effects. What is meant here in particular by an optically variable effect is an effect with defined different visual appearances in defined different viewing situations, in particular at different viewing angles.

The one or more leveling layers are in particular varnish layers. Preferably, the one or more leveling layers, in particular the one or more decorative layers, are transparent and/or colorless and/or colored. The one or more leveling layers may, for example, have a third color which is different than the first and/or second color or which corresponds to the first color and/or the second color. It is alternatively or additionally possible that the one or more leveling layers have one or more replication layers, which in particular is or has been provided with a surface structure, preferably a microstructure.

In a multicore heating conduit in ribbon form, a first leveling layer is or has been preferably provided on a first side of the multicore heating conduit, in particular in such a way that the leveling layer extends along a surface parallel to a surface which is formed by a longitudinal direction of a heating wire and a direction which connects several center lines of the heating wires. In addition, it is possible that a second leveling layer is or has been provided on a second side of the multicore heating conduit opposite the first side. It is possible that the first leveling layer has the third color and/or the second leveling layer has the third color and/or a fourth color which differs from the first and/or second and/or third color or corresponds to the first and/or second and/or third color.

It is additionally possible that, in the one or more outer layers and/or the one or more leveling layers, in particular in the first and/or second leveling layer, one or more recesses and/or structurings are provided, which are in particular in motif form, for example taking the form of one or more lines, an inscription and/or a logo. A motif formed by the one or more recesses and/or structurings may, for example, also extend across several outer layers, which is preferred in particular in a multicore heating conduit in ribbon form. The one or more recesses and/or structurings are or have been preferably generated by a laser ablation, preferably after step iv) and/or after step IV) and/or in step a), and/or by a laser blackening, for example after the before or after one of steps b) and c). In this way, it is possible to further improve the design options and, for example, to provide film bodies with short setup times with individualized multicore heating conduits.

It is also possible by means of the one or more recesses to expose one or more regions of the at least one heating wire and/or the one or more further heating wires, in particular such that a metal used for the heating wires is visible and/or contributes to a visible effect in the heating film composite, in the layer composite and/or in the film body. In particular, owing to regions in which the respective outer layers are conserved, the heating wires are preferably spaced apart from one another. Advantageously, it is thus possible, for example, to utilize the optical effect of the metallization of the heating wire in regions without further material and/or to accept an increase in the thickness of the multicore heating conduit. It is also conceivable to combine such recesses and/or structurings with several different-colored outer layers.

In a preferred embodiment of the film body, lens structures may be or have been provided in the film body, preferably for enlarged representation of motifs and/or color effects provided by means of the multicore heating conduit, in particular for enlargement of one or more motifs formed by the one or more recesses and/or structurings, for example a logo, and/or of one or more motifs and/or color effects formed by the first, second, third and/or fourth color and/or by surface structures of the one or more outer surfaces. Such lens structures may be or have been provided in particular in one or more of the following layers and/or components: the first carrier component, the second carrier component, the protective varnish layer, the baking varnish layer. The lens structures are preferably produced by stamping processes and/or embossing processes and/or replication processes and/or laser structuring processes.

The enlarged representation may be on a local scale, i.e. in particular in that there is enlargement of portions of the multicore heating conduit. The enlarged representation can be further emphasized by partial backlighting, for which a backlighting device can be provided in the film body, and/or further emphasised by subsequently applied lens structures.

The one or more outer layers comprise or preferably consist of one or more of the following materials: polyester, polyacrylate, PMMA, melamine, melamine-formaldehyde resins, epoxy acrylates, polyether acrylates, polyester acrylates, acrylates, epoxy polymethacrylate, polyurethane, polystyrene, polybutyrate, nitrocellulose, polyvinylchloride, ethylene-vinyl acetates, copolymers thereof or similar polymers, additives, fillers, pigments, dyes.

The one or more insulation layers comprise or preferably consist of one or more of the following materials: polyester, polyacrylate, PMMA, melamine, melamine-formaldehyde resins, epoxy acrylates, polyether acrylates, polyester acrylates, acrylates, epoxy polymethacrylate, polyurethane, polystyrene, polybutyrate, nitrocellulose, polyvinylchloride, ethylene-vinyl acetates, copolymers thereof or similar polymers, additives, fillers, pigments, dyes.

The one or more baking varnish layers comprise or preferably consist of one or more of the following materials: thermally curable water-based hotmelt adhesives, thermally curable solvent-based hotmelt adhesives, epoxy resins, epoxy resin mixtures.

The one or more leveling layers comprise or preferably consist of one or more of the following materials: polyester, polyacrylate, PMMA, melamine, melamine-formaldehyde resins, epoxy acrylates, polyether acrylates, polyester acrylates, acrylates, epoxy polymethacrylate, polyurethane, polystyrene, polybutyrate, nitrocellulose, polyvinylchloride, ethylene-vinyl acetates, copolymers thereof or similar polymers, additives, fillers, pigments, dyes.

The one or more outer layers preferably have a layer thickness within a range from 0.5 μm to 100 μm. The one or more insulation layers preferably have a layer thickness within a range from 0.5 μm to 100 μm. The one or more baking varnish layers preferably have a layer thickness within a range from 0.5 μm to 100 μm. The one or more leveling layers preferably have a layer thickness within a range from 1 μm to 500 μm.

The minimum distance between two or more heating wires of the at least one heating wire and the one or more further heating wires is preferably within a range from 0.5 μm to 10 μm. The maximum distance between two or more heating wires of the at least one heating wire and the one or more further heating wires is preferably within a range from 10 μm to 500 μm and/or the multicore heating conduit has a width and/or a diameter within a range from 10 μm to 500 μm. The width and/or the diameter is measured in particular in cross section, preferably that with the smallest area. Depending on the measuring direction, there may be variation in the width of the cross section of the multicore heating conduit.

It is preferable that the at least one heating wire and/or one the or more further heating wires consist of copper or comprise copper, in particular predominantly, i.e. comprise preferably more than 50 percent by mass, further preferably more than 95 percent by mass. It is thus possible to use a particularly inexpensive and readily available material. As already explained above, it is thus possible in particular, for example by adjusting the multicore heating conduit, to achieve a sufficient heating output with favorable materials and special optical effects.

It is preferably possible that the multicore heating conduit has 2 to 10 heating wires. Alternatively or additionally, it is preferable that in the multicore heating conduit the sum total of the minimum widths and/or sum total of the diameters of all heating wires of both the at least one heating wire and the one or more further heating wires is at least 50 μm, preferably at least 80 μm, and/or not more than 1000 μm, preferably not more than 120 μm. The diameter refers in particular only to conductive material of the heating wires. The total resistance, which can be calculated in particular by means of the resistances of the heating wires both of the at least one heating wire and of the one or more further heating wires, is preferably at least 0.5Ω, preferably at least 22Ω, and/or not more than 1000Ω, preferably not more than 137Ω. Preferably, the multicore heating conduit has a length of at least 0.5 m and/or not more than 250 m, for example a length of 4 m.

It is also possible that one or more heating wires of the one or more further heating wires have a first diameter and one or more heating wires of the one or more further heating wires have a second diameter, where the first diameter differs from the second diameter and is internal. Preferably, the first diameter is within a range from 100% to 500% of the second diameter, for example 150% of the second diameter. Advantageously, therefore, it is possible to utilize thin heating wires, for example in order to provide fine surface structures and/or fine color differences of the surface of the multicore heating conduit. It is possible to achieve a sufficient heating output while avoiding burnthrough of thin wires in that there are thicker wires with lower resistance parallel thereto.

The at least one heating wire likewise preferably has the second diameter or a diameter greater than the second diameter. It is possible that there are the same number of heating wires with the first diameter and heating wires with the second diameter. Alternatively or additionally, it is possible that the number of heating wires with the first diameter and/or the number of heating wires with the second diameter is within a range from 1 to 10, for example 4.

The layer composite and/or the heating film composite, in particular the first composite, and/or the at least one carrier film preferably has a passive heating layer or is provided or endowed with a passive heating layer. The passive heating layer in particular has low transparency for infrared radiation and/or is opaque to infrared radiation and/or absorbs infrared radiation. It is thus possible for the passive heating layer to be heated by sunlight, for example, and thus in particular to have a supportive effect in heating and advantageously to reduce the necessary heat output of the heating wire. It is also possible that the passive heating layer is advantageously arranged such that the heat radiation emitted by the heating wire is at least partly absorbed by the passive heating layer and hence preferably directed more homogeneously and/or with greater intensity to the surface to be heated within the film body. Preferably, the passive heating layer is or has been arranged behind the one or more decorative plies from the visible side. The passive heating layer comprises or preferably consists of one or a combination of the following materials: organic and/or inorganic layers, inorganic layers, organic pigments, inorganic pigments, polymers, active substances, nanotubes. The passive heating layer may in particular also have surface structuring that supports the absorption effect, for example in the form of matte structures or of moth's eye structures, in particular with a high depth/width ratio.

Preferably, a contacting element is provided and/or a contacting element is possessed by the at least one carrier film in the layer composite and/or the heating film composite, in particular the first composite. It is thus possible that the film body and/or the layer composite and/or the heating film composite, in particular the first composite, is or has been provided with a contacting element. The contacting element, in particular of the layer composite and/or the heating film composite, in particular of the first composite, and/or of the film body, is or has been preferably designed so as to be at least partly freely accessible, preferably designed so as to be freely accessible after step iv) and/or after step IV) and/or after step b) and/or after step c). In particular, the contacting element enables electrical contact with the at least one heating wire and/or the multicore heating conduit. It is also possible that the at least one heating wire and/or the multicore heating conduit is contactable and/or contacted by means of a solder site, i.e. is connectable and/or connected in particular to an energy source and preferably a control unit. The multicore heating conduit preferably has a contact site in each case at one or both ends, in particular by means of a solder site, at which several or all heating wires of the at least one heating wire and the one or more further heating wires are galvanically bonded and/or in electrically conductive contact with one another. It is possible that the solder site is created before and/or during one of the following steps: step a), step I), step i), and/or that the solder site is created after one of the following steps: step iv), step IV), step b), step c). Preferably, the solder site is created by automatic guidance of a soldering station, in particular by means of a robot arm. Preferably, in a previous step, for example by laser ablation, a site on the heating wires at one end or at both ends of the multicore heating conduit is exposed by removal of areas of the one or more outer layers. In particular, a laser unit is used for this purpose, which is guided automatically, in particular by means of a robot arm.

The contacting element is or has been designed in particular in such a way that it is suitable for electrical contacting of the at least one heating wire and/or the multicore heating conduit. The contacting element remains free of first and second carrier component in the production of the film body, in particular at least in a contacting region.

It is possible that the contacting element having at least one end, in particular two ends, of the at least one heating wire and/or of the multicore heating conduit and/or at least one end of the at least one heating wire and/or of the multicore heating conduit that has been provided with a contact reinforcement, in particular two ends of the at least one heating wire and/or the multicore heating conduit, preferably each provided with a contact reinforcement, is or has been formed. Such contact reinforcements advantageously at the same time provide an enlarged contact area and a mechanical reinforcement in the contacting region. It is alternatively or additionally possible that the contacting element is or has been formed with one or more of the following layers: at least one electrically conductive layer, in particular comprising or consisting of one or more materials selected individually or in combination from Cu, Ag, Au, Zn, at least one electrically insulating layer, at least one adhesion promoter layer, at least one nonstick layer. The contacting element may be or may have been adhesive-bonded in particular by means of electrically conductive adhesive, preferably at least on the at least one heating wire and/or the multicore heating conduit. The contacting element, in particular before step iv) and/or before step IV) and/or step a), is or has been brought into contact with the at least one heating wire and/or the one or more further heating wires, preferably partly between two layers of the heating film composite and/or layer composite.

The contacting element comprises, within the contacting region, in particular at least the at least one carrier film, in particular the first carrier film or the second carrier film, and the at least one heating wire and/or the one or more further heating wires. The heating wire and/or the one or more further heating wires can thus be led out of the body provided with the first and second carrier component through the at least one carrier film. It is optionally possible that the contacting element includes the at least one decorative ply in some regions or over the full area, for example when one or more decorative plies of the at least one decorative ply is or has been applied to the at least one carrier film or another layer of the layer composite over the full area or virtually over the full area.

The contacting region may be formed, for example, by means of a region not accessible during step b) and/or c) by the first and/or second free-flowing composition, for example by means of a corresponding cavity of an injection mold, in particular of the first and/or second mold and/or the first and/or second slit shape and/or one or more metallic inserts for adjusting the cavity. Alternatively or additionally, it is possible that the contacting region is or has been formed by a region not accessible by the first and/or second free-flowing composition during step b) and/or c) by means of the slit in the apparatus. Alternatively or additionally, it is also possible, in particular after steps b) and/or c), to clear a region of the film body while conserving the contacting region, for example by grinding, milling, drilling, cutting, punching, etching, chemical removal and/or laser ablation.

It is appropriate that at least some regions of an outer surface of the contacting element are or have been formed by a nonstick layer. The at least one nonstick layer advantageously forms at least one outer surface of the contacting element. This outer surface can be brought into contact with a mold shape, in particular with the first and/or second slit shape, in the production of the film body, such that the contacting element may be or may have been configured with at least some regions not in the cavity and/or so as to be free of the first carrier component and the second carrier component at least in some regions. In this case, damage-free detachment from the first and/or second slit shape can advantageously be achieved by means of the nonstick layer.

The apparatus is in particular an injection molding apparatus. It is possible that the apparatus has one or more injection channels for introducing the first and/or second and/or third free-flowing injection molding material into the cavity.

It is possible that the second slit shape and the second mold shape are formed at least partly by a monolithic component. A monolithic component is in particular understood to mean a component that consists of a single piece and/or has no detachable connection. It is also conceivable that component halves, in particular a monolithic component, are inserted into the cavity and then subjected to in-mold coating in combination with said film body.

It is possible that the first slit shape and the second slit shape are formed such that, in the closed state, the slit has a first cross-sectional area and a second cross-sectional area, where the first cross-sectional area is closer to the cavity and has a smaller area than the second cross-sectional area. The first slit shape and/or the second slit shape are in particular formed as a mold insert for forming part of a corresponding cavity half. Preferably, the first and second slit shapes, at least in some regions or in their entirety, form a contact edge of both cavity halves. Preferably, the slit is formed in the closed state in accordance with the geometry of the contacting element. Preferably, leaktightness of the slit is ensured as part of sealing of the cavity. The slit is preferably adjusted exactly to the thickness of the contacting element, such that the slit is left sufficiently wide that the contacting element is not mechanically destroyed on closure of the mold, e.g. crushed or sheared off, and the slit is sufficiently narrow at the same time that the first slit shape and the second slit shape are close to the contacting element in order to seal the cavity together with the contacting element, especially at the high pressures and temperatures in the in-mold coating operation.

For this purpose, it is advantageous when at least one of the slit shapes is not formed in one piece with the respective mold shape, but in each case forms an interchangeable module that can be adjusted accordingly such that the slit can be adjusted to different thicknesses of the tail.

In particular, on viewing perpendicular to the first cross-sectional area and the second cross-sectional area, the first cross-sectional area is completely surrounded by the second cross-sectional area. Preferably, on viewing perpendicular to the first cross-sectional area, a first region of the slit is apparent, preferably with a constant cross section and/or a defined length, for example within a range from 3 cm to 350 cm. In particular, on viewing perpendicular to the second cross-sectional area, a second region of the slit is apparent, preferably with a constant or spatially varying cross section and/or a defined length, for example within a range from 3 cm to 350 cm. In particular, this enables generation of a high pressure and hence a strong sealing effect on the cavity, which enables, for example, a compact design of the apparatus and elevated process reliability. Preferably, the releasable connection is inserted in a cavity with the second cross-sectional area. In particular, this has the advantage of a simple means of adjustment of the slit in a more compact and lightweight design, thereby potentially saving capacities and resources for the manufacture of the apparatus and in operation of the apparatus.

It is possible that the apparatus comprises an ultrasonic sonotrode which is configured in particular such that insertion of the heating wire into a layer of the layer composite and/or of the multicore heating conduit into a layer of the heating film composite and/or that of the layer composite is implementable.

There follows an illustrative elucidation of the invention by several working examples with reference to the appended drawings. The figures show:

FIGS. 1 to 9 schematic diagrams of a layer composite and a film body,

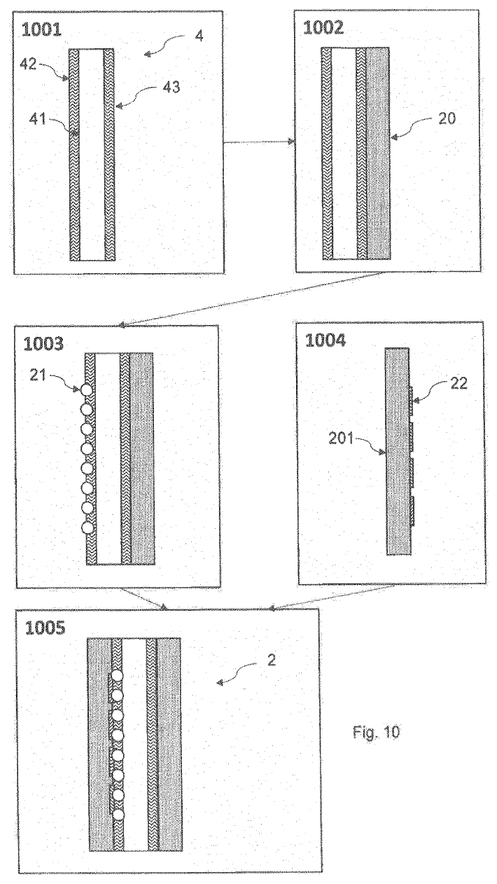

FIG. 10 a schematic of a method,

FIGS. 11 to 13 schematic diagrams of a layer composite,

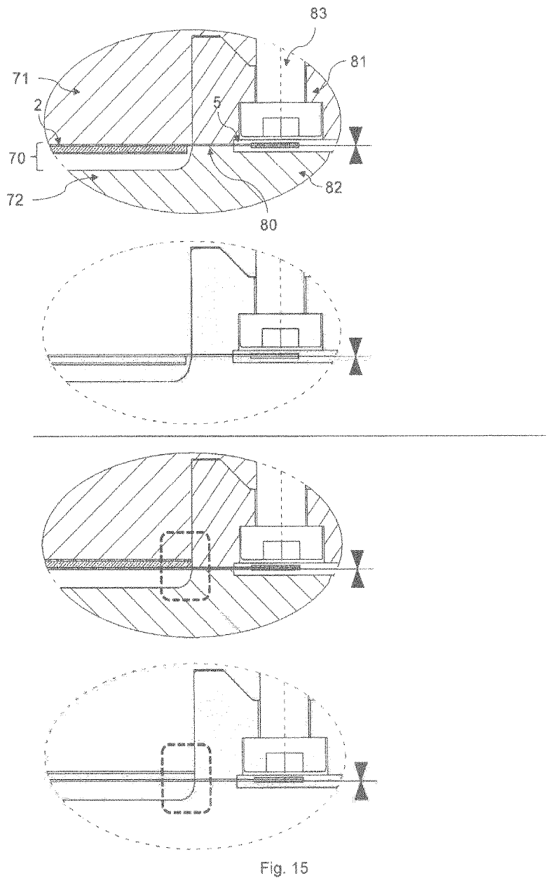

FIG. 14 a schematic of a section of an apparatus,

FIG. 15 a schematic of an apparatus,

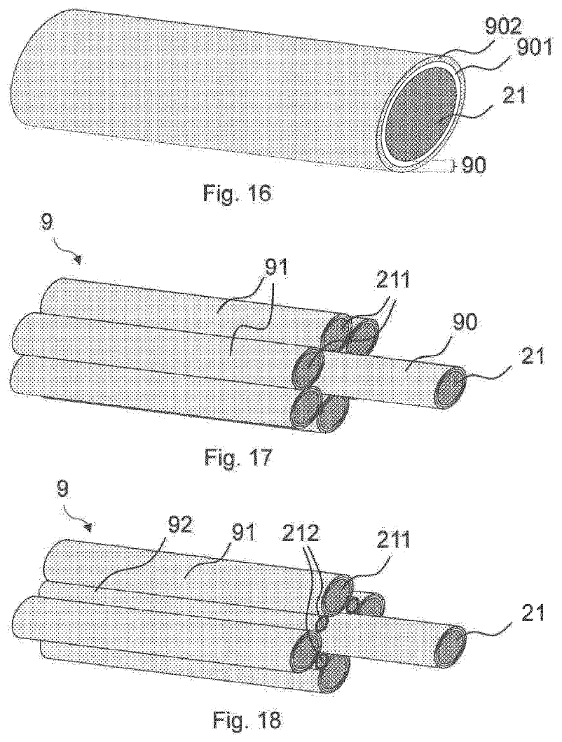

FIG. 16 a schematic of a heating wire,

FIGS. 17 to 20 schematic diagrams of a multicore heating conduit,

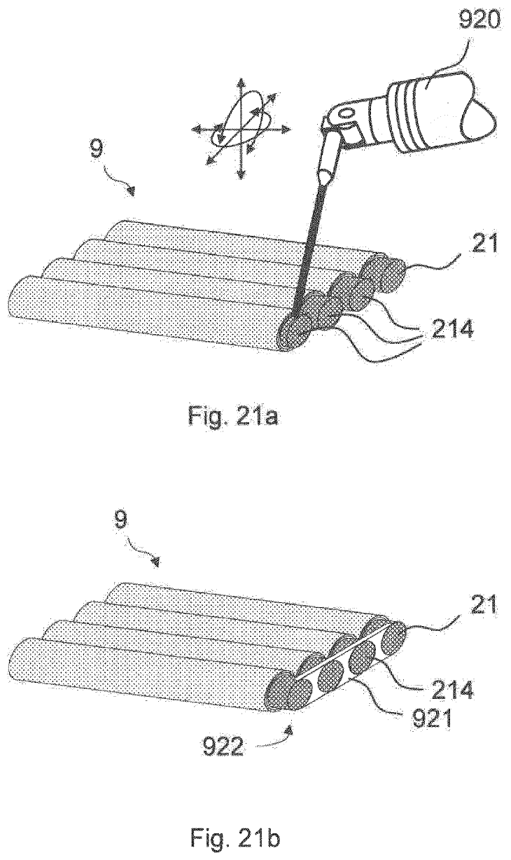

FIGS. 21a and 21b schematics of a method of creating contact sites, and

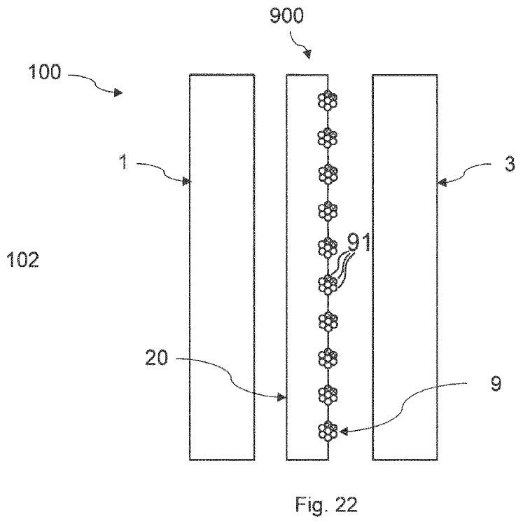

FIG. 22 a schematic diagram of a heating film composite and a film body.

FIG. 1 shows a schematic of a cross section of a film body 100. The film body 100 has a first carrier component 1, a layer composite 2 and a second carrier component 3.

The layer composite 2 is preferably produced by the method of the invention for producing a layer composite. Preferably, the layer composite 2 is suitable for use in a method of producing a film body 100 and/or is used in such a method, in particular where the layer composite 2 is provided with the first carrier component 1 and the second carrier component 3, and hence the film body 100 is obtained. The layer composite 2 is in particular an insert element. The insert element can be inserted, for example, in the method of producing the film body 100 into a cavity of an injection molding apparatus, in particular the apparatus of the invention. The layer composite 2 is in particular an insert element for performance of steps b) and c), which is provided in step a).

The layer composite 2 has at least one carrier film, which is illustrated by way of example in FIG. 1 by the first carrier film 20. Moreover, the layer composite 2 has at least one decorative ply, which is illustrated by way of example in FIG. 1 by the first decorative ply 22. In addition, the layer composite 2 has at least one heating wire, which is illustrated by way of example in FIG. 1 by the heating wire 21. The at least one heating wire 21 has a minimum width and/or a smallest diameter of 50 μm. The at least one heating wire 21 also has a minimum cross-sectional area of 2500 μm², which is measurable in particular in a cross section, as shown by FIG. 1.

The at least one carrier film 20, the at least one decorative ply 22 and the at least one heating wire 21 are bonded to one another, preferably in a cohesive bond. It is conceivable to provide additional layers, such as adhesion layers or adhesive layers between the layers of the layer composite 2.

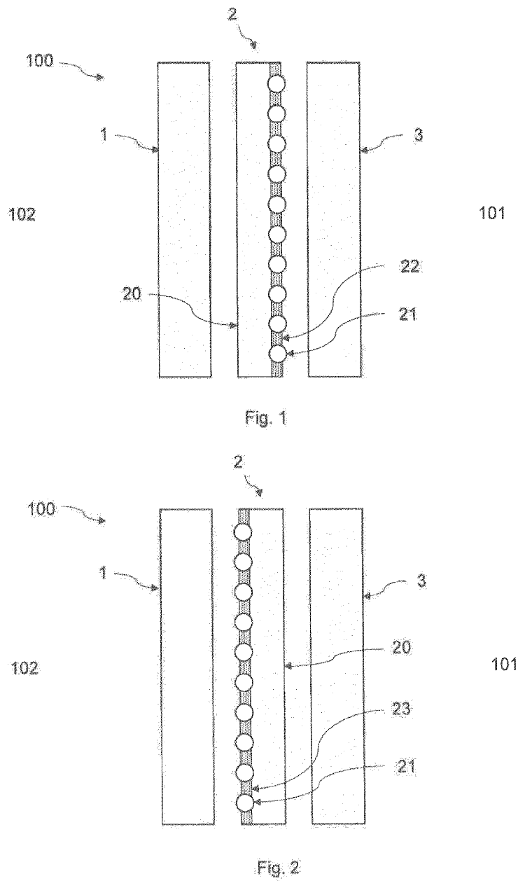

The heating wire 21 may be arranged in particular, in the embodiments shown in FIG. 1 and FIG. 2, in different ways on and/or in the decorative ply 22 and/or on and/or in the carrier film 20. This respectively different arrangement may depend on one or more of the following conditions: energy input from the fixing of the heating wire 21 on the respective backing, the material of the carrier film 20, the material of the heating wire 21, minimum width and/or smallest diameter of the heating wire 21, cross-sectional shape of the heating wire 21, dwell time of the energy input when fixing the heating wire 21 on the respective backing, thermal conductivity of the heating wire 21, thermal conductivity of the decorative ply 22, thermal conductivity of the carrier film 20.

This different arrangement of the heating wire 21 in each case may, for example, be as follows:
a) the heating wire 21 may have been embedded in the carrier film 20 and in the decorative ply 22 or
b) the heating wire 21 may have been embedded solely in the decorative ply 22 or
c) the heating wire 21 may have been embedded in the decorative ply 22 and partly embedded in the face of the carrier film 20, depending on position, or
d) the heating wire 21 may rest on the decorative ply 22 and only partly be embedded in the decorative ply 22 and not embedded in the carrier film 20.

The layer composite 2 can be obtained by the method of producing a layer composite. The method comprises the steps of:
i) providing at least one carrier film, which in FIG. 1 by way of example comprises the first carrier film 20,
ii) providing at least one decorative ply, which in FIG. 1 by way of example comprises the first decorative ply 22,
iii) providing at least one heating wire, which in FIG. 1 by way of example comprises the heating wire 21, where the heating wire 21 has a minimum width and/or a smallest diameter of 50 μm and a minimum cross-sectional area of 2500 μm², and
iv) bonding, preferably cohesively bonding, the at least one carrier film, in particular the first carrier film 20, the at least one decorative ply, in particular the first decorative ply 21, and the at least one heating wire, in particular the heating wire 21.

It is possible that the bonding in step iv) of the at least one heating wire, in particular the heating wire 21, is accomplished using ultrasound, as described in particular further above.

The bonding iv) preferably comprises hot stamping of one or more decorative plies of the at least one decorative ply, in particular the first decorative ply 21, preferably onto the at least one carrier film 20. The decorative ply 21 is provided, for example, as a removable transfer ply of a hot stamping film. In particular, the hot stamping film is brought into contact with the first carrier film 20 and the transfer ply is transferred to the first carrier film 20 by means of a heated stamping tool. For this purpose, the transfer ply may, for example, have a hotmelt adhesive layer, which is brought into contact with the carrier film 20, for example, and then the transfer ply is parted from the hot stamping film. The transfer may take place over the full area or in the form of a motif. For this purpose, the embossing tool may, for example, have a full-area or motif-shaped embossing surface. The embossing surface may be smooth and flat or may have a surface relief structure. For example, the surface relief structure may be a matte structure.

It is also possible that one or more decorative plies of the at least one decorative ply, in particular the decorative ply 22, are a full-area and/or motif-shaped print layer, preferably a print varnish layer, and/or are printed on. For bonding in step iv), such print layers can be applied in particular by one or more of the following steps, in particular to the at least one carrier film: gravure printing, screen printing, inkjet printing, flexographic printing, digital printing, offset printing. The print layers can also first be produced in a transfer ply of a transfer film, in particular hot stamping film, and bonded to the transfer ply with the at least one carrier film.

FIG. 1 shows, in particular, a visible side 101 and a reverse side 102. What is meant in particular by reverse side and front side is opposite sides, in particular opposite sides of a respective layer or of the layer composite 2. Preferably, a front side of a respective layer or of the layer composite 2 or of parts thereof faces the visible side 101, and a reverse side of a respective layer or of the layer composite 2 or of parts thereof faces away from the visible side 101. The reverse side of the first carrier film 20 is or has been provided in particular as a side of the carrier film 20 that faces away from the visible side 101 of the film body 100. The first decorative ply 22 is or has been positioned in particular on a reverse side of the first carrier film 20. The front side of the first carrier film 20 is or has been provided in particular as a side of the carrier film 20 that faces the visible side 101 of the film body 100. The film body 100 is viewed from the visible side 101 or on this side, in particular in an installed state, and/or the film body 100 and the layer composite 2 is or has been designed for viewing of this visible side 101. What is meant in particular by the visible side of the film body 100 is thus the part of the film body 100 that is visible from the visible side 101.

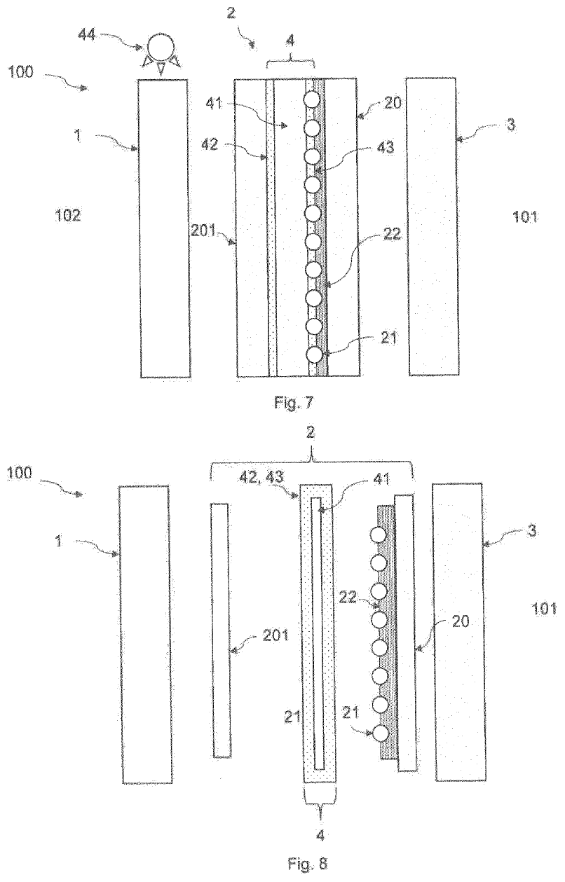

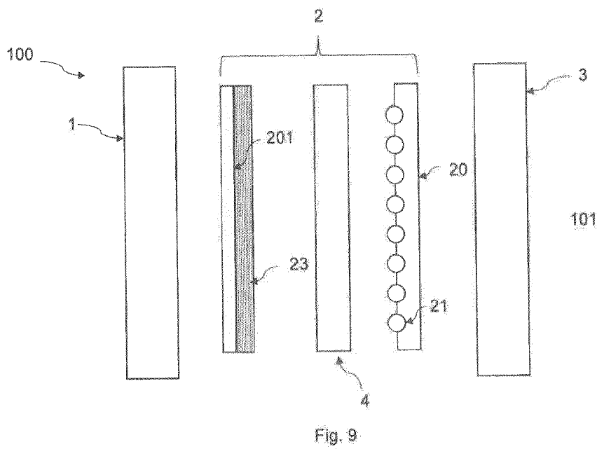

It is possible that, alternatively or additionally to the first decorative ply 22, one or more further decorative plies, such as in particular the second decorative ply 23, is or has been positioned on the reverse side of the carrier film 20. This is illustrated in particular by way of example with reference to FIGS. 2, 4, 5 and 6. As illustrated by way of example by any of FIG. 7, FIG. 8 and FIG. 9, it is also possible that the first decorative ply 22 and/or a second decorative ply 23 are or have been positioned between a first carrier film 20 and a second carrier film 201, i.e. on a front side of a second carrier film 201 and/or a reverse side of a first carrier film 20. As can be seen, for example, from FIGS. 1 and 2, the second decorative ply 23 does not necessarily presuppose that the first decorative ply 22 is present.

As illustrated by way of example by FIG. 1, it is possible that the film body 100 comprises the carrier film 20, the decorative ply 22 and the heating wire 21 with a minimum width and/or a smallest diameter of 50 μm and a minimum cross-sectional area of 2500 μm², in particular in the form of the layer composite 2, and comprises the first carrier component 1 and the second carrier component 3. A protective varnish layer may optionally be or have been provided in the film body 100. In particular, it is possible that a protective varnish layer is or has been provided in place of the second carrier component 3 or in addition to the second carrier component 3, preferably on the second carrier component 3, in particular on the visible side 101 of the second carrier component 3. The second carrier component 3 and/or the protective varnish layer is thus formed in particular on a visible side of the film body 100. The layer composite 2 may be or have been preferably produced independently of the film body 100 and, for example, be temporarily stored and/or transported before the film body 100 is produced with the layer composite 2. However, it is also conceivable that the layer composite 2 is formed only as a result of the method of producing the film body 100 and/or that one or more components from the at least one decorative ply, the at least one carrier film and the at least one heating wire are provided individually in the method of producing the film body 100 and, for example, are connected to one another only by means of the first carrier component 1.

The surface of the film body 100, in particular of the second carrier component 3 and/or of the protective varnish layer (not shown here), forms regions or the full area of the heatable surface of a cover element, which is transmissive in particular to electromagnetic waves. It is possible that the layer composite 2 is connectable or connected to a radiation source, as elucidated by way of example in particular for the optional embodiments of FIGS. 7 to 9. The cover element is thus formed in particular by at least the second carrier component 3 and/or the protective varnish layer (not shown here). It is also possible that the cover element is or has been formed additionally by the layer composite 2 or the entire film body 100. In particular, it is possible that the film body 100, in particular on the reverse side 102, has or is connectable to a radiation source, preferably where the cover element is formed by the first carrier component 1, the layer composite 2 and the second carrier component 3 and/or the protective varnish layer.

The film body 100 is in particular produced by the method of producing the film body. The method of producing the film body 100 having a heatable surface of a cover element which is transmissive for electromagnetic waves in particular comprises the following steps:
a) providing
at least one carrier film, such as the first carrier film 20 described by way of example with reference to one of FIGS. 1 to 9 and/or the second carrier film 201 described by way of example with reference to one of FIGS. 7 to 9,
at least one decorative ply, such as the first decorative ply 22 and/or second decorative ply 23 described by way of example with reference to one of FIGS. 1 to 9, and
at least one heating wire, such as the heating wire 21 described by way of example with reference to one of FIGS. 1 to 9, where the heating wire 21 has a minimum width and/or a smallest diameter of 50 μm and a minimum cross-sectional area of 2500 μm²,
b) in-mold coating or flow coating the at least one carrier film, such as the first carrier film 20 described by way of example with reference to one of FIGS. 1 to 9 and/or the second carrier film 201 described by way of example with reference to one of FIGS. 7 to 9, the at least one decorative ply, such as the first decorative ply 22 and/or second decorative ply 23 described by way of example with reference to one of FIGS. 1 to 9, and the at least one heating wire such as the heating wire 21 described by way of the example with reference to one of FIGS. 1 to 9, in particular in-mold coating or in-mold flow coating a reverse side of the layer composite 2 with a first free-flowing composition to obtain the first carrier component 1, in particular on the reverse side of the film body 100;
c) applying a second free-flowing composition to a front side proceeding from the at least one carrier film, in particular the first carrier film 20 and/or the second carrier film 201, preferably of the layer composite 2, to obtain the second carrier component 3 on a visible side of the film body 100. Alternatively or additionally, the applying of a second free-flowing composition can give a protective varnish layer on a visible side of the film body 100, in particular by flow coating and/or overpainting. It is also possible that a third free-flowing composition is used for the flow coating and/or the overpainting, in particular where this is applied to the second carrier component 3 which is preferably obtained from the second free-flowing composition.

The steps may be performed in the sequence specified. It is also conceivable that step a) only takes place through step b) in that the layer composite is obtained in step b). Preferably, the providing of the at least one decorative ply, the at least one carrier film and the at least one heating wire can be conducted in the form of the layer composite 2, which is subjected to in-mold coating or flow coating in step b), preferably on its reverse side.

It is not shown, but is also possible in particular that the first carrier film 20 and the at least one heating wire 21 are provided in step a) in the form of a first composite, where the first decorative ply 22 is fixedly integrated into the layer composite 2 and/or into the film body 100, in particular by an IMD method, in step b) or in step c). In this case, the carrier film 20 including heating wire 21 and the decorative ply 22 are preferably positioned on opposite sides of a cavity and the first carrier component 1 is formed between them.

Step b) can especially be performed with the materials of the above versions. In this example, PC is preferred for the first free-flowing composition.

Step c) can especially be performed with the materials of the above versions. In this example, PC is preferred for the second free-flowing composition for overmolding and/or PUR for flow coating and/or a 2K varnish is preferred for overpainting.

In the layer composite 2 described in FIG. 1, applying of the at least one decorative ply, in particular the first decorative ply 22, is preferably followed by applying and/or inserting the at least one heating wire onto the at least one decorative ply, in particular the first decorative ply 21. Thus, the at least one heating wire 21 is or has been positioned on the front side of the layer composite 2 and/or the visible side 101 of the film body 100 and covers the at least one decorative ply, in particular the first decorative ply 22, in particular on viewing of the layer composite 2 or the film body 100, preferably from the visible side. The applying of the at least one decorative ply, in particular the first decorative ply 22, is or has been preferably conducted by gravure printing, screen printing, hot stamping, cold stamping, inkjet printing, flexographic printing, digital printing, offset printing. Subsequently, for production of the film body 100, in-mold coating of the reverse side of the is conducted, for example, with a first free-flowing composition comprising or consisting of PC, and flow coating of the front side of the layer composite 2 is conducted, for example, with a second free-flowing composition comprising or consisting of PU, and/or overpainting of the front side of the layer composite 2 and optionally of the second carrier component 3 which is obtained by flow coating is conducted, for example, with a third free-flowing composition, which is, for example, a varnish, preferably a clearcoat, which preferably comprises or consists of acrylates. It is possible that the steps for in-mold coating or flow coating of the first, second and/or third free-flowing composition and/or all flow coating method steps are conducted in one apparatus. It is possible that the first, second and/or third free-flowing composition are introduced by forming a cavity in each case, preferably by means of two mold halves, in particular by replacing at least one of the mold halves, for example after step b), preferably a first in-mold coating or flow coating operation, to alter the cavity or generate another cavity, such that, for example, step c) can then be effected with this other cavity, and in particular a further in-mold coating and/or flow coating operation can take place in this other cavity. This can also be done several times in succession by changing at least one half of the mold. This can enable high process reliability and low costs. Subsequent printing steps and/or painting steps are preferably performed outside the cavity.

A particular advantage of a layer composite 2 and film body 100 as described in FIG. 1 for example is that the at least one heating wire 21 can be positioned particularly close to the top end of the part and so preferably at least some of the heat generated can reach the heatable surface without heating the at least one carrier film beforehand. Advantageously, the film body 100 includes the at least one heating wire directly adjoining the second carrier component 3 and/or the protective varnish layer, and/or the layer composite 2 includes the at least one heating wire 21 on an exposed surface on a front side of the layer composite 2.

As illustrated by way of example with reference to FIG. 2, it is also possible that one or more decorative plies of the at least one decorative ply, in particular the second decorative ply 23, and the at least one heating wire 21 are or have been positioned on the same side, in particular the reverse side, of the at least one carrier film, in particular the first carrier film 20. Preferably, the at least one decorative ply, in particular the second decorative ply 23, is or has been positioned on the reverse side of the at least one carrier film, preferably the first carrier film 20, and the at least one heating wire 21 on a reverse side of the at least one carrier film, preferably the first carrier film 20, and in particular inserted into the at least one decorative ply, preferably the second decorative ply 23, and the at least one carrier film, preferably the first carrier film 20. A decoration is thus visible through the at least one carrier film from the front side of the layer composite 2 and/or the visible side of the film body 100. It is possible that the at least one heating wire penetrates or has penetrated with a penetration depth within a range from 50% to 80% of its minimum width and/or its thickness in the direction of the layer thickness of the at least one decorative ply and/or of the at least one carrier film into the at least one decorative ply and the at least one carrier film. In this case, the at least one heating wire passes in particular through the layer thickness of the at least one decorative ply. In particular, it is possible that the at least one heating wire has at least 5 times the thickness, preferably at least 20 times the thickness, of the layer thickness of the at least one decorative ply in the direction of the layer thickness of the at least one decorative ply. Advantageously, the heating wire can thus be used as decoration. At the same time, it is possible to provide a distance optimized for the heat distribution additionally by means of the at least one carrier film.

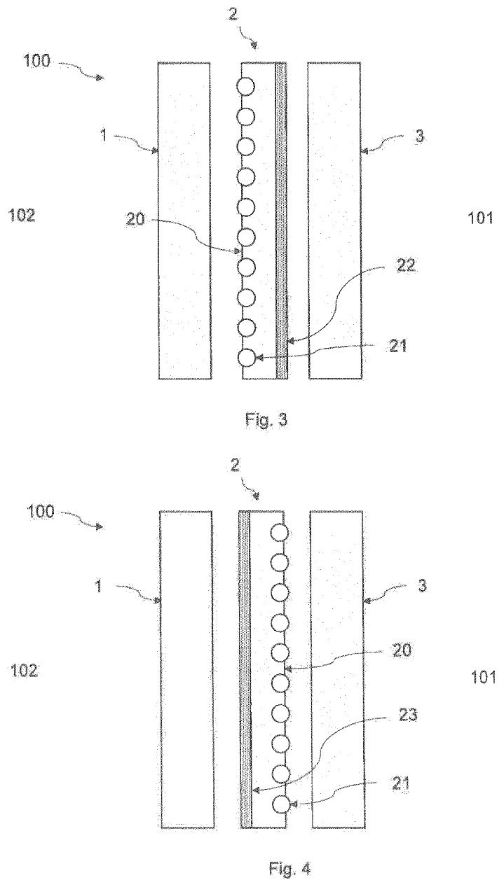

As illustrated by way of example with reference to FIG. 3, it is also possible that one or more decorative plies of the at least one decorative ply, in particular the first decorative ply 22, and the at least one heating wire 21 are or have been positioned on opposite sides of the at least one carrier film, in particular the first carrier film 20. Preferably, the at least one decorative ply, in particular the first decorative ply 22, is or has been positioned on the front side of the at least one carrier film, preferably the first carrier film 20, and the at least one heating wire 21 on a reverse side of the at least one carrier film, preferably the first carrier film 20. In this case, it is possible that the at least one heating wire is applied to and/or inserted into the at least one carrier film before the application of the at least one decorative ply. It is possible that the at least one decorative ply, in particular after the application of the at least one heating wire, is conducted by hot stamping.

If, for example, the at least one heating wire is applied first, subsequent decoration is possible by hot stamping, for example. It is also possible that the at least one decorative ply, in particular after the application of the at least one heating wire, is applied by IMD methods. In this IMD method, preferably, an IMD film comprising the at least one decorative ply, in particular the first decorative ply 22, is positioned on one side of a cavity, and the at least one carrier film, in particular the carrier film 20, with the at least one heating wire 21 is positioned on another side of the cavity, and an injection molding material, in particular comprising the first or second free-flowing composition, is inserted between the at least one decorative ply, in particular the decorative ply 22, and the at least one carrier film, in particular the carrier film 20.

By the IMD method, it is preferably possible that the overmolding and/or flow coating is conducted. It is also possible that the applying of the at least one decorative ply is conducted by other methods, such as in particular the other methods described.

What is particularly advantageous about a version as described in FIG. 3 is that it is possible to form at least one decorative ply that is not penetrated by the at least one heating wire and hence more flexible design options are provided, and that, depending on the requirements, an optimized heat distribution can be provided by means of the distance from the heated surface, which can be adjusted by means of at least one carrier film.

As illustrated by way of example with reference to FIG. 4, it is also possible that one or more decorative plies of the at least one decorative ply, in particular the second decorative ply 23, and the at least one heating wire 21 are or have been positioned on opposite sides of the at least one carrier film, in particular the first carrier film 20, preferably where the at least one decorative ply, in particular the second decorative ply 23, is or has been positioned on the reverse side of the at least one carrier film, preferably the first carrier film 20, and the at least one heating wire 21 is or has been positioned on a front side of the at least one carrier film, preferably the first carrier film 20. In this case, it is possible that the at least one heating wire is applied to and/or inserted into the at least one carrier film before the application of the at least one decorative ply. It is possible that the at least one decorative ply, in particular after the application of the at least one heating wire, is conducted by hot stamping.

If, for example, the at least one heating wire is applied first, subsequent decoration is possible by hot stamping, for example. It is also possible that the at least one decorative ply, in particular after the application of the at least one heating wire 21, is applied by IMD methods. In the IMD method, preferably, an IMD film comprising the at least one decorative ply is positioned on one side of a cavity and the at least one carrier film with the at least one heating wire is positioned on another side of the cavity, and an injection molding material, in particular comprising the first or second free-flowing composition, is inserted between the at least one decorative ply and the carrier film. By the IMD method, it is preferably possible that the overmolding and/or flow coating is conducted.

It is also possible that the applying of the at least one decorative ply is conducted by other methods, such as in particular the other methods described.

In contrast to the example illustrated by FIG. 3, in which the decoration is in particular on the visible side of the at least one carrier film, the decoration in FIG. 4 is, for example, on the reverse side of the carrier film, i.e. visible through the at least one carrier film from the visible side of the film body 100 and/or from the front side of the layer composite 2. The at least one heating wire 21, especially on viewing from the visible side, is positioned in front of or above the decoration and is visible, as also illustrated in particular with regard to FIG. 1.

What is advantageous about an embodiment as described with regard to FIG. 4 is, for example, that the at least one heating wire 21 can be positioned close to the heatable surface. In addition, it is advantageously possible to achieve a wider range of design options for the at least one decorative ply, since the at least one heating wire is not in direct contact with the decorative ply on the opposite side.

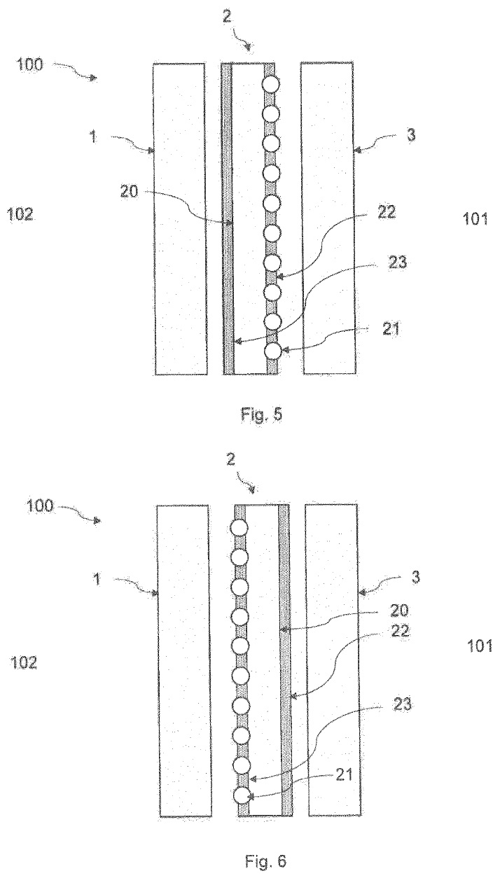

It is also possible to combine the versions described with regard to FIGS. 1 and 4. In particular, it is thus possible to obtain or produce a layer composite 2 and/or film body 100 as shown in FIG. 5.

It is also possible to combine the versions described with regard to FIGS. 2 and 3. In particular, it is thus possible to obtain or produce a layer composite 2 and/or film body 100 as shown in FIG. 6.

It is thus possible in particular that a first side of the at least one carrier film is or has been provided with at least one first decorative ply and the at least one heating wire, and that a second side opposite the first side is or has been provided with at least one further decorative ply. In particular, the first side may constitute either the front side or the reverse side of the at least one carrier film. It is thus possible at the same time to achieve an optimized heat distribution with increased design options. The at least one decorative ply on the first side and the at least one further decorative ply on the second side overlap and/or preferably complement one another visually, for example as complementary patterns and/or motifs and/or else as a color mixture or as combinations thereof.

As illustrated by way of example by FIG. 1 to FIG. 6, it is possible that the at least one heating wire 21 is or has been applied on a front side or a reverse side of the at least one carrier film. It is further possible that the at least one heating wire 21 is or has been inserted into one or more layers or is selected from: the at least one decorative ply, in particular the first decorative ply 22 or the second decorative ply 23, the first carrier film 20, the second decorative ply 23. It is further possible that the at least one heating wire 21 is or has been applied and/or is or has been inserted on the first side of the first carrier film 20 or on the second side of the first carrier film 20. Preferably, the at least one heating wire 21 can be inserted into several layers in that it fully penetrates a layer such as the at least one decorative ply, in particular the first decorative ply 22 or the second decorative ply 23, and/or the at least one decorative ply, in particular the first decorative ply 22 and/or the second decorative ply 23, is or has been applied only over part of the area, in particular in the form of a motif, where the at least one heating wire 21 extends in particular over the at least one decorative ply, in particular the first decorative ply 21 and/or the second decorative ply 23. The at least one decorative ply, in particular the first decorative ply 22 and/or the second decorative ply 23, is or has been preferably positioned on a front side and/or a reverse side of the first carrier film 21.

There follows an optional example of layer thicknesses and materials of the versions illustrated by FIGS. 1 to 6. The first carrier component 1 is formed in particular from transparent PU and has a layer thickness of 0.2 mm to 20 mm, preferably when the carrier component 1 is the A side (visible side) of the finished component. The second carrier component 3 is in this case in particular formed from PC and has a layer thickness of 0.2 mm to 20 mm.

However, it may also be that the first carrier component 1 is formed from PC with a layer thickness of 0.2 mm to 20 mm. In this case, the second carrier component 3, which now constitutes the A side (visible side) of the component, is or has been preferably formed from transparent PU. The layer thickness of the second carrier component 3 is preferably within a range from 0.2 mm to 20 mm.

The heating wire 21 is formed in particular from copper and has a circular cross section with a diameter of 100 μm. The first carrier film 20 is formed in particular from PC and has a layer thickness of 375 μm. The first decorative ply 22 is in particular a print layer having a layer thickness of 10 μm or a transfer ply of a hot stamping film and has a layer thickness of 15 μm. The first decorative ply 22 may, over the full area or only in parts of the area, be transparent or transparently colored or translucent or opaque. The second decorative ply 23 is in particular a print layer having a layer thickness of 25 μm or a transfer ply of a hot stamping film and has a layer thickness of 5 μm. The second decorative ply 23 may, over the full area or only over parts of the area, be transparent or transparently colored or translucent or opaque. The optional protective varnish layer in particular has a layer thickness of 12 μm and is formed by a dual cure varnish and is in particular transparent, preferably crystal clear and transparent.

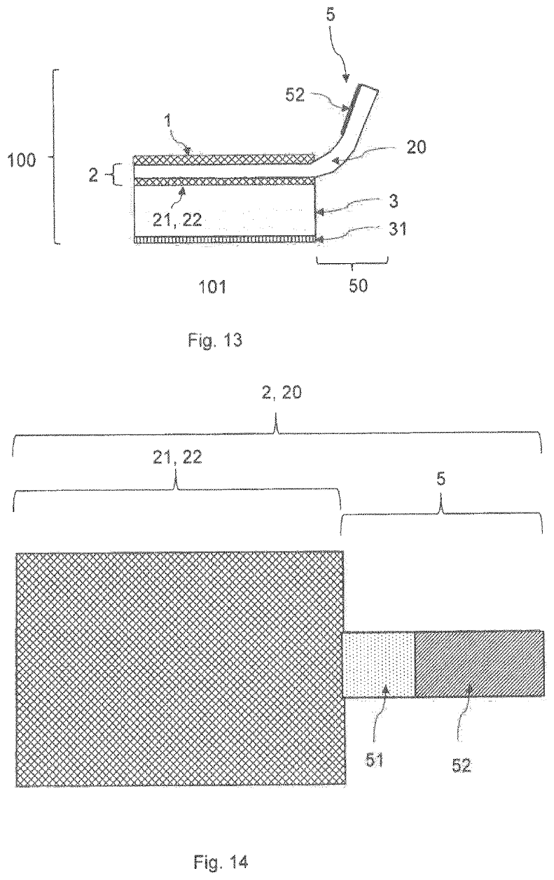

In a preferred embodiment, which may be shown in particular by way of example with reference to FIG. 7 to FIG. 9, it is possible that the at least one heating wire 21 is additionally positioned between the first carrier film 20 and a substrate 4 which has a reflection layer 41. In addition, it is possible that, in particular after steps b) and c), the at least one heating wire 21 in the film body 100 is or has been positioned between the first carrier component 1 and the second carrier component 3. Moreover, it is possible that the at least one heating wire 21 and/or a contacting element 5 protrudes from the film body 100 and is or has been formed so as to be free of the first carrier component 1 and/or second carrier component 3, as elucidated in detail, in particular, by way of example with regard to one of FIGS. 13 to 15.

In addition to the heating wire 21, one or more further heating wires may optionally also be inserted into the layer composite 2. It is preferable that only one heating wire and/or only one plane of the layer composite 2 and/or the film body 100 is or has been provided with one or more heating wires.

FIG. 7 shows a schematic of a layer composite 2 and a film body 100 with the layer composite 2 and the first carrier component 1 and the second carrier component 3. As illustrated by way of example by FIG. 7, it is possible that the layer composite 2 additionally includes a substrate 4. The substrate 4 in particular includes at least one reflection layer 41, where the reflection layer 41 preferably comprises or consists of PMMA. In particular, the reflection layer 41 comprises one or more of the following materials: PMMA, PMMA derivatives, modified PMMA. The reflection layer 41 is or has been preferably applied with a layer thickness within a range from 1 μm to 75 μm, in particular 50 μm. As further illustrated by FIG. 7, it is possible that the film body 100 has a light source 44 or is provided with a light source 44. By means of this light source 44, it is possible to inject light into the film body 100. The incident light is preferably incident on or at the reverse side 102 and/or laterally. In particular, the incident light is incident at least into the first carrier component 1 or incident into a material of the finished film body 100 comprising the first carrier component 1 and optionally, for example, the carrier film 201.

Preferably, the reflection layer 41 includes a material which forms an optical interface at least in the finished film body 100 together with at least one adjacent layer, in FIG. 7 for example at least with the carrier film 201 and/or the adhesive layer 42 or the material comprising this/these layer(s), for example comprising the first carrier component 1 and the carrier film 201. The reflection layer 41 here is designed in particular in such a way that a difference in refraction index exists at the interface. Reflection of the light injected by means of the light source 44 thus takes place at this optical interface. This optical interface is at least partly reflective, meaning in particular that a fraction of the light injected laterally by the light source 44 is reflected at the interface and another fraction in the direction of the decorative ply 22 and the heating wire 21 is allowed through the interface. This means that the incident light is thus advantageously partly trapped in the layer structure in order to achieve at least weak backlighting of the decorative ply 22. It is possible thereby, in particular in addition to a headlight function, for example, to enable preferably slight glowing for backlighting of the at least one decorative ply.

It is also possible that the substrate 4 has one or more adhesive layers, for example the first adhesive layer 42 and/or the second adhesive layer 43, which is preferably positioned on a side of the substrate 4 facing the first carrier film 20 and/or on a side facing away from the first carrier film 20.

The first decorative ply 22 is shown over the full area here too, but may also be or have been provided in part, in particular in motif form.

The first carrier component 1 comprises or preferably consists of PC. In particular, the first carrier component is or has been applied by in-mold coating. The second carrier component 3 comprises or likewise preferably consists of PC. In particular, the second carrier component 3 is or has been applied by overmolding.

In particular, PC and PMMA are frequently transparently selected materials. In a preferred embodiment, therefore, the layers formed from PC and/or PMMA are preferably transparent. However, it may also be the case that materials that have been subjected to in-mold coating on the reverse side (the opposite side from the visible side 101), in particular up to the at least one decorative ply, are opaque and hence cover the reverse side in a fully opaque manner, for example if no backlighting is required, or cover it in an only partly opaque manner, for example as a backlight mask and/or backlight shielding, but with the rest of the reverse side transparent or translucent.

The front side of the film body 100 and/or, for example, at least the materials from the visible side 101 up to the heating wire 21, up to the at least one decorative ply, in particular the decorative ply 22, up to the at least one carrier film, in particular the carrier film 20 and/or the carrier film 201, are preferably transparent, at least translucent, and in particular include the correspondingly applied materials (for example by injection molding, flow coating, printing).

The first adhesive layer 42 and/or the second adhesive layer 43 is or has been preferably applied with a layer thickness within a range from 5 μm to 120 μm, in particular 50 μm. The first adhesive layer 42 and/or second adhesive layer 43 is preferably transparent.

The first carrier film 20 and/or the second carrier film 201 is or has been preferably applied with a layer thickness within a range from 100 μm to 375 μm, in particular 120 μm.

“Transparent” or “translucent” refers here preferably to visible light.

FIG. 8 shows a schematic of a layer composite 2 as described in particular with regard to FIG. 7, and a film body 100 with the layer composite 2, the first carrier component 1 and the second carrier component 3. The adhesive layers 42 and 43 may optionally be formed here by an adhesive surrounding the reflection layer 41. Preferably, instead of the surrounding adhesive, as can be seen for example in FIG. 7, two separate adhesive layers 42 and 43 are formed. It is thus also possible that the substrate 4 has one or more adhesive layers, for example the first adhesive layer 42 and/or the second adhesive layer 43, which is preferably positioned on a side of the substrate 4 facing the first carrier film 20 and/or on a side facing away from the first carrier film 20.

As illustrated by way of example by FIG. 8, it is possible that the at least one decorative ply, in particular the first decorative ply 22, is applied in a decoration step to the first carrier film 20, in particular is applied to the first side of the carrier film 20.

In a coating step, it is possible in particular that the reflection layer 41 is provided with one or more adhesive layers, in particular the first adhesive layer 42 and/or the second adhesive layer 43. In addition, it is possible that, in a further step, the second carrier film 201 is provided and bonded to the substrate 4.

The at least one heating wire 21 is preferably applied to the at least one decorative ply, in particular the first decorative ply 22. It is possible here for the at least one heating wire 21 also to be inserted into the first decorative ply 22 and optionally the first carrier film 20. It is then possible to bond the first carrier film 21 to the first decorative ply 22 and the at least one heating wire 21 to the substrate 4 which preferably has the one or more adhesive layers. In particular, the at least one heating wire 21 is positioned between the substrate 4 and the first carrier film 20. On the side facing away from the heating wire 21, the second carrier film 201 may then be applied beforehand or subsequently.

The first carrier film 20 can advantageously generate good adhesion with the second carrier component 3 and/or the protective varnish layer. The second carrier film 201 can advantageously generate good adhesion with the first carrier component 1.

As illustrated by FIG. 9 by way of example, it is also possible that one or more decorative plies, in particular the second decorative ply 23, is or has been applied to the second carrier film 201. It is possible here, for example, that the first carrier film 20 has no decorative ply, as can be seen in FIG. 9 for example, or that the first carrier film 20 includes the first decorative ply 22 and there is additionally at least one further decorative ply, such as the second decorative ply 23, on the second carrier film 201. Expressions such as “first” and “second” are used accordingly, in particular, for distinction, where a “second” decorative ply preferably does not necessarily presuppose the existence of a “first” decorative ply. It is thus also possible that the at least one heating wire 21 is first applied to the first carrier film 20 and in particular introduced into the first carrier film 20. In particular, it is possible that the at least one heating wire 21 is applied solely to the first carrier film 20 and preferably introduced into the first carrier film 20. Preferably, the at least one heating wire 21 is then positioned between the substrate 4 and the first carrier film 20, and substrate 4, first carrier film 20 and the at least one heating wire 21 are bonded.

It is also possible that the second carrier film 201 is or has been bonded to the substrate 4, where the second decorative ply 23 is or has been arranged between the second carrier film and the substrate.

As described by way of example with reference to FIG. 8 and FIG. 9, a preferred layer composite 2 has a substrate 4 which is preferably positioned with at least some regions between a first carrier film 20 and a second carrier film 21. Further preferably, the first carrier film 20 is or has been preferably arranged between the substrate 4 and the second carrier component 3, and/or the second carrier film 201 between the substrate 4 and the first carrier component 1. It is alternatively or additionally also possible that the first carrier film 20 is positioned between the substrate 4 and the optional protective varnish layer 31.

It is also conceivable that, in a working example as described in particular with regard to FIGS. 1 to 9, a multicore heating conduit is or has been provided rather than the heating wire 21 and/or a multicore heating conduit comprising the heating wire 21. It is possible here that the first decorative ply 22 and/or the second decorative ply 23 is present or absent. As is described in detail by way of example with regard to FIG. 22, the multicore heating conduit itself may already have a special optical effect.

FIG. 10 shows a schematic of an illustrative method of producing a layer composite 2. In this case, the at least one heating wire 21 in particular is applied to the substrate 4 and/or inserted into the substrate 4.

In a first step 1001, the reflection layer 41 of the substrate 4 is provided, for example, with the adhesive layers 42 and 43 on both sides.

In a second step 1002, the first carrier film 20 is provided and applied to the substrate 4, in particular laminated. What is meant here by laminating is in particular a process involving pressure and/or temperature.

In a third step 1003, the at least one heating wire 21 is inserted into the substrate 4, in particular into an adhesive layer positioned on a side of the reflection layer 41 facing away from the first carrier film 20, such as preferably the adhesive layer 42.

In a fourth step 1004, which can be conducted in particular in a sequence independent of steps 1001, 1002 and 1003, a second carrier film 201 is provided with one or more decorative plies of the at least one decorative ply. FIG. 10 shows, for example, the decorative ply 22.

In a fifth step 1005, the first carrier film 20, the decorative ply 22 and the at least one heating wire 21 are bonded and the layer composite 2 is obtained. This involves applying, preferably laminating, the second carrier film 201 to the substrate 4. Preferably, the decorative ply 22 and the at least one heating wire 21 are positioned between the second carrier film 201 and the substrate 4.

It is then possible that the layer composite 2 is formed, in particular by means of an HPF process (HPF=high-pressure forming). This involves forming the layer composite 2 at high pressure and low temperature, in particular a pressure within a range from 80 bar to 120 bar at a temperature within a range from 80° C. to 150° C.

It is further possible to supply the layer composite 2 as an insert element to the method of producing the film body 100, in particular an injection molding process, by means of which the film body 100 is obtainable, as described in particular for the method of producing a film body.

It is also conceivable that, in the method, rather than the heating wire 21, the multicore heating conduit is inserted into the substrate 4 and/or that the heating wire 21 is encompassed by the multicore heating conduit on insertion into the substrate 4.

FIG. 11 shows a schematic of a cross section in the left-hand image and a top view of a layer composite 2 in the right-hand image. Such a top view is in particular a view perpendicular to a plane formed by the layer composite. It is possible that, on viewing of the visible side of the film body 100, the layer composite 2, as shown in particular schematically by the top view of FIG. 11, is visible, in particular visible through the second carrier component 3 and/or the protective varnish layer, further preferably visible at least in some regions or fully. As additionally illustrated by way of example by FIG. 11, it is possible here that the at least one heating wire 21 is visible and, in particular, the at least one decorative ply, preferably the first decorative ply 21, is positioned behind the at least one heating wire 21 on viewing of the visible side.

The layer composite 2 may optionally include one or more protective layers, such as the illustrated protective layer 27. An adhesive layer may also be or have been positioned in place of the protective layers 27, or the protective layer 27 may fulfill an adhesive function.

The layer composite 2 may optionally include one or more primer layers, such as the primer layer 26 depicted. An adhesive layer may also be or have been positioned in place of the primer layer 26, or the primer layer 26 may fulfill an adhesive function.

It is possible that the at least one heating wire, in particular when viewed perpendicular to a plane formed by the layer composite 2, covers an area within a range from 0.1% to 50%, preferably within a range from 1% to 10%, more preferably within a range from 1% to 5%. The area covered is, in particular, the area of the region of the layer composite 2 that overlaps with the at least one heating wire 21, divided by the total area of the layer composite 2, in particular the at least one carrier film.

In particular, it is possible that the layer composite 2, for example on viewing of FIG. 11, has the following illustrative properties:
width of 100 cm,
length of 100 cm,
area 10 000 cm²,
distance d, preferably minimum distance d, between opposite, in particular parallel, conductor tracks of the at least one heating wire: 0.5 cm
number of mutually opposite, in particular parallel, conductor tracks of the at least one heating wire: 200,
distance of the at least one heating wire from opposite ends of the layer composite, in particular ends at the top and bottom in FIG. 11: 1 cm.
length of the at least one heating wire 19 600 cm,
diameter of the at least one heating wire: 100 μm,
area covered: 196 cm² (=length of the at least one heating wire x diameter of the at least one heating wire).
area coverage of the at least one heating wire: 1.96% (=percentage of the area occupied by the at least one heating wire in relation to the total area, which can be seen in particular as in FIG. 11 in top view).

The total area can thus be determined in particular from the product of the width and length of the layer composite 2.

A preferred determination of the above values can be made as follows:

Fₛₕₑₑₜ=Bₛₕₑₑₜ×Lₛₕₑₑₜ
with Fₛₕₑₑₜ=area of the heating element; Bₛₕₑₑₜ=width; Lₛₕₑₑₜ=length)

L_{heating wire}=(Bₛₕₑₑᵣ−Sₒ−Sᵤ)×A
with L=length of the heating wire (preferably without bends); Sₒ=upper edge margin; Sᵤ=lower edge margin; A=number of wire tracks)

F_{heating wire}=(L_{heating wire}×D_{heating wire})
(F_{heating wire}=area of the heating wire (preferably without bends); L_{heating wire}=length of the heating wire (preferably without bends); D_{heating wire}=diameter of the heating wire)

$${Bel}_{heating wire} = \frac{( {F}_{heating wire} ) \times 100}{{F}_{sheet}}$$

(Fₛₕₑₑₜ=area of the heating element; F_{heating wire}=area of the heating wire (preferably without bends); Bel_{heating wire}=percentage of the overall heating element area containing heating wire).

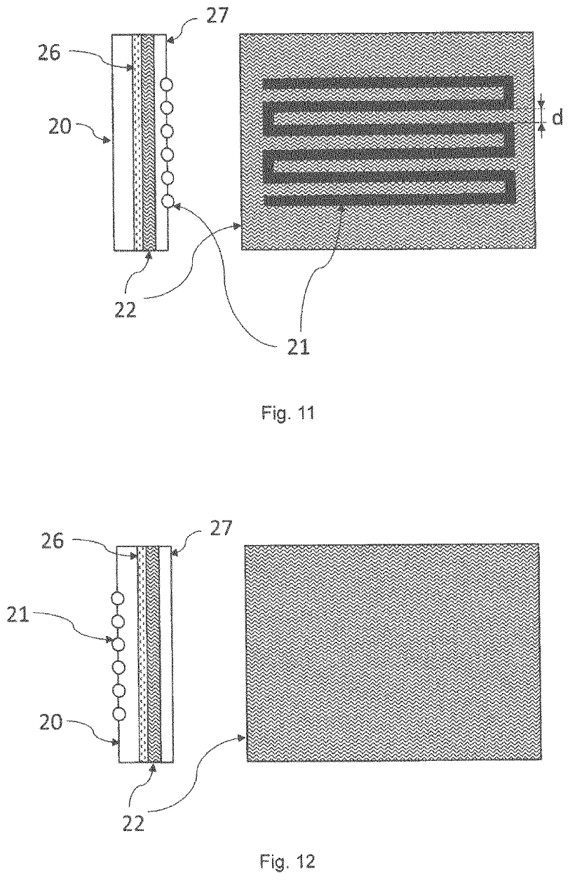

FIG. 12 shows a schematic of a cross section in the left-hand image and a top view of a layer composite 2 in the right-hand image. It is possible that, on viewing of the visible side of the film body 100, the layer composite 2, as shown in particular schematically by the top view of FIG. 11, is visible, in particular visible through the second carrier component 3 and/or the protective varnish layer, further preferably visible at least in some regions or fully. As additionally illustrated by way of example by FIG. 12, it is possible here that the at least one heating wire 21 is concealed and, in particular, the at least one decorative ply, preferably the first decorative ply 21, is positioned in front of the at least one heating wire 21 on viewing of the visible side. The layer composite 2 of the example detailed with regard to FIG. 12 may be or have been constructed in particular as the layer composite 2 described in FIG. 11, except that the at least one heating wire is or has been positioned on a reverse side of the layer composite 2.

The decorative ply 22, which is detailed for example with regard to FIG. 11 and/or FIG. 12, may in particular also be a transparent or semitransparent decorative ply. In the illustrative FIG. 11 and FIG. 12, the decorative ply 22 is provided over the full area. It is also possible that the decorative ply 22 is in motif form. In particular, the decorative ply 22, when viewed from the visible side, may be partly concealed by the at least one heating wire 21 and/or the heating wire may be at least partly concealed by the decorative ply 22.

It is also possible that the decorative ply 22 itself has one or more layers. For example, the decorative ply 22 may be a print layer, in particular print varnish layer or a vapor-deposited layer, in particular a metal layer, or a print layer, in particular print varnish layer, having a vapor-deposited layer thereon, in particular metal layer.

FIG. 13 shows, by way of example, a schematic cross section of a layer composite 2 with a contacting element 5. The layer composite 2 may be constructed in particular as described with regard to one of FIGS. 1 to 12, where the layer composite additionally includes the contacting element 5.

The contacting element 5 is or has been designed in particular in such a way that it is suitable for electrical contacting of the at least one heating wire 21 and/or the multicore heating conduit which may especially include the heating wire 21.

The layer composite 2 is shown in FIG. 13 as part of the film body 100, but can in particular also be produced separately, and preferably used in the method of producing the film body 100 as an insert element, so as to obtain a film body 100 comprising the layer composite 2. It is also possible that the layer composite 2 is formed as part of the film body 100 during the method of producing the film body 100. The film body 100 may optionally include or have been provided with the protective varnish layer 31.

The film body 100, as illustrated by way of example by FIG. 13, includes the layer composite 2 which is or has been positioned with some regions between the first carrier component 1 and the second carrier component 3, in particular before steps b) and c) are conducted. In addition, the film body 100 and/or the layer composite 2, in particular also after step b) and after step c), includes a contact region 50 free of first carrier component 1 and second carrier component 3. This contacting region 50 is provided in particular by the contacting element 5.

The contacting element 5, in particular before step iv) and/or step a), is or has been brought into contact with the at least one heating wire 21, or comprises the at least one heating wire 21, preferably partly between two layers of the layer composite. The at least one heating wire 21 may be possessed in particular by the contacting element 5 or be or have been positioned between the contacting element 5 and the first carrier component 1 or between the contacting element 5 and the second carrier component 3. In this case, it is possible that the contacting element 5 itself comprises or is formed from one or more layers of the layer composite 2. It is possible that the contacting element 5 is or has been formed with one or more of the following layers: at least one electrically conductive layer comprising or consisting of a conductive layer of Cu, Ag, Au and/or Zn, at least one electrically insulating layer, at least one adhesion promoter layer, at least one nonstick layer. The contacting element 5 may have been bonded in particular by means of electrically conductive adhesive, in particular to the at least one heating wire 21. Preferably, the at least one heating wire 21 is or has been directly contacted with the electrically conductive layer.

It is also possible that the contacting element 5 is or has been formed by at least one end, in particular two ends, of the at least one heating wire 21. Preferably, the heating wire 21 is fixed to the end of the contacting element 5 in the contacting region 50. Optionally, a contact reinforcement 52 may be or may have been provided in the contacting region 50. It is possible that the contacting element 5 has two ends of the heating wire 21, each end being provided with a contact reinforcement 52. Such contact reinforcements advantageously at the same time provide an enlarged contact area and a mechanical reinforcement in the contacting region 50.

The contacting element 5 comprises in particular at least the first carrier film 20 and the heating wire 21 within the contacting region 50. It is optionally possible that the contacting element 5 includes the decorative ply 22 or 23 in some regions or over the full area, for example if at least one of these is or has been applied to the carrier film 20 or another layer of the layer composite 2 over the full area or virtually over the full area. The contacting region 50 may be formed, for example, by means of a region not accessible during step b) and/or c) by the first and/or second free-flowing composition, for example by means of a corresponding cavity of an injection mold, in particular of the first and/or second mold and/or the first slit shape and/or the second slit shape and/or one or more metallic inserts for adjusting the cavity, free of first carrier component 1 and free of second carrier component 3. Alternatively or additionally, it is possible that the contacting region 50 is formed by a region not accessible by the first and/or second free-flowing composition during step b) and/or c) by means of the slit in the apparatus, preferably a first slit shape and/or a second slit shape. An illustrative apparatus having a corresponding first slit shape 81 and a second slit shape 82 is described in particular with regard to FIG. 15. Alternatively or additionally, it is also possible, in particular after steps b) and/or c), to clear a region of the film body 100 while conserving the contacting region 50, for example by grinding, milling, drilling, cutting, punching, etching, chemical removal and/or laser ablation.

FIG. 14 shows a view from below, in particular from the visible side 101, of a layer composite 2 as described with regard to FIG. 13. It is also possible that FIG. 14 shows a view from below of a film body 100 as described with regard to FIG. 13, where the first carrier component 1, the second carrier component 3 and optionally the protective varnish layer 31 are or have been additionally provided in the region with the layers 20, 21 and 22.

As shown by way of example with reference to FIG. 14, it is also possible that the layer composite has a nonstick layer 51 in the contacting region 50. It is appropriate that at least some regions of an outer surface of the contacting element 5 are or have been formed by the nonstick layer 51. The nonstick layer 51 advantageously forms at least one outer surface of the contacting element 5. This outer surface can be brought into contact with a mold shape, in particular with the first and/or second slit shape, in the production of the film body 100, as described in particular with regard to FIG. 15, such that the contacting element 5 may be or may have been configured with at least some regions not in the cavity and/or so as to be free of the first carrier component 1 and the second carrier component 3 at least in some regions.

It is possible that the contacting element 5 has a layer, in particular the first carrier film 20 shown in FIG. 13, which is present over the full area or part of the area in the contacting region 50 and between the first carrier component 1 and the second carrier component 3, preferably in the layer composite 2. The contacting element 5 may optionally also have further layers in the contacting region 50, in particular layers on the carrier film 20, which are also present over the full area or part of the area between the first carrier component 1 and the second carrier component 3, preferably in the layer composite 2.

FIG. 15 shows a schematic of a detail of an example of an apparatus, in particular injection molding apparatus. This apparatus is used in particular for performing a method of producing the film body 100, preferably as described in one of FIGS. 13 and 14, or is suitable for such a method. The apparatus is preferably used for performance of step b) and/or step c).

The upper two details refer in particular to a first version and the lower two details to a second version.

The apparatus comprises means of forming a cavity 70, which have at least one first mold shape 71 and a second mold shape 72. The first mold shape 71 and the second mold shape 72 are movable into a closed state in which the cavity 70 is formed by at least the first mold shape 71 and the second mold shape 72, as can be seen, for example, in the upper image.

The apparatus additionally comprises means of forming a defined slit 80 adjacent to the cavity, which have at least a first slit shape 81 and a second slit shape 82, wherein the slit 80 is formed in the closed state of at least the first slit shape 81 and the second slit shape 82. At least one of the first slit shape 81 and the second slit shape 82 is connected to the first mold shape 71 and/or to the second mold shape 72 via a releasable connecting element 83. By way of example, in FIG. 15, the first slit shape 81 is connected to the first mold shape 81 via a screw connection by means of the screw 83.

It is also preferably possible that the second slit shape 82 and the second mold shape 72 are at least partly formed by a monolithic component, as can be seen by way of example in FIG. 15.

It is also possible that, as illustrated by way of example in FIG. 15, the first slit shape 81 and the second slit shape 82 are formed such that, in the closed state, the slit 80 has a first cross-sectional area and a second cross-sectional area, where the first cross-sectional area is closer to the cavity 70 and has a smaller area than the second cross-sectional area. Thus, in particular, it is possible to implement clamping of the contacting element by means of the first and second slit shape in a region of the contacting element provided for this purpose, which has been provided with a nonstick layer, for example. Moreover, in the region of the second cross-sectional area, the releasable connection may be or may have been provided, in particular without impairing the contacting element 5 in the closed state.

The upper two details in FIG. 15 show a slit shape 81, which is configured, for example, to use a layer composite 2 as insert element, which has the at least one heating wire 21 on the reverse side and/or the front side of the layer composite 2, in particular the at least one carrier film. As can be seen in particular with reference to the dashed region of the lower two details in FIG. 15, it is possible to use a slit shape 81 which is configured to use a layer composite 2 as an insert element which has the at least one heating wire 81 on the visible side and/or the first side of the at least one carrier film. Advantageously, the change in gap shape is simple owing to the releasable connection, and the gap shape can be integrated in a compact and procedurally reliable design, in particular owing to the widened cross section in the region of the releasable connection.

In this case, leaktightness of the slit 80 is ensured as part of the sealing of the cavity 70. The slit 80 is preferably adjusted exactly to the thickness of the contacting element 5, such that the slit 80 is left sufficiently wide that the contacting element 5 is not mechanically destroyed on closure of the mold, e.g. crushed or sheared off, and the slit 80 is sufficiently narrow at the same time that the first slit shape 81 and the second slit shape 82 are close to the contacting element 5 in order to seal the cavity 70 together with the contacting element 5, especially also at the high pressures and temperatures in the in-mold coating operation. For this purpose, it is advantageous when at least one of the slit shapes 81 and 82 is not formed in one piece with the respective mold shape 71 or 72, but in each case forms an interchangeable module that can be adjusted accordingly such that the slit 80 can be adjusted to different thicknesses of the contacting element 5.

It is possible that the film body 100 is produced by executing steps b) and/or c) for in-mold coating or in-mold flow coating and/or for applying the first, second and/or third free-flowing composition, and/or all in-mold coating, in-mold flow coating, overspray and/or flow coating method steps are conducted in the apparatus. It is possible that the first, second and/or third free-flowing composition are introduced by forming a cavity in each case, preferably by means of mold halves, such as the first mold shape 71 and the second mold shape 72, in particular by replacing at least one of the first mold shape 71 and the second mold shape 72, for example after a first in-mold coating operation in step b), to alter the cavity 70 or generate another cavity, such that, for example, a further in-mold coating and/or flow coating operation can take place in this other cavity for performance of step c). This can also be done several times in succession by changing at least one half of the mold.

FIG. 16 shows a schematic of the heating wire 21. As illustrated thereby by way of example, it is possible that the heating wire 21 has an outer layer 90. The outer layer 90 comprises in particular an insulation layer 901 and a baking varnish layer 902. The insulation layer 901 is positioned in particular directly on the heating wire 21 and produced preferably by means of at least one nozzle coating and/or at least one dip coating and/or at least one spray coating and/or at least one vapor deposition operation, preferably from one or more materials from the group or groups of the polyesters, polyacrylates, PMMA, melamines, melamine-formaldehyde resins, epoxy acrylate, polyether acrylate, polyester acrylates, acrylates, epoxy polymethacrylate, polyurethane, polystyrene, polybutyrate, nitrocellulose, polyvinyl chloride, ethylene-vinyl acetates, copolymers thereof or similar polymers, additives, fillers, pigments, dyes, and especially with a layer thickness of 10 μm. The baking varnish layer 902 is bonded to the heating wire 21 in particular via the insulation layer 902 and produced in particular by means of at least one nozzle coating and/or at least one dip coating and/or at least one spray coating and/or at least one vapor deposition operation from one or more materials from the group of thermally curable water-based hotmelt adhesives, thermally curable solvent-based hotmelt adhesives, epoxy resins, epoxy resin mixtures, and especially with a layer thickness of 20 μm. The outer layer 90 thus preferably has a layer thickness of 30 μm.

The heating wire 21, illustrated by FIG. 16, has a minimum width and a smallest diameter of 50 μm and a minimum cross-sectional area of 2500 μm². FIG. 17 to FIG. 20 show the heating wire 21 by way of example in a multicore heating conduit 9. In this case, the heating wire 21 may be designed as described in FIG. 16, with the difference that it is also possible that the heating wire 21 has a smaller width and/or a smaller diameter and/or a smaller cross-sectional area. In addition to the heating wire 21, the multicore heating conduit 9 additionally comprises one or more further heating wires, such as the heating wires 211, 212, 213 and 214 illustrated by FIGS. 17 to 20 for example. The further heating wires, for example the heating wires 211, 212, 213 and 214, may likewise be designed like the heating wire 21 described with regard to FIG. 16, except that it is also possible that the further heating wires have a smaller width and/or a smaller diameter and/or a smaller cross-sectional area. The heating wire 21 and the further heating wires are galvanically isolated from one another by one or more outer layers, such as the outer layers 90, 91, 92 and/or 93. The one or more outer layers, such as the outer layers 90, 91, 92 and/or 93, are or have been positioned in the film body so as to be at least partly visible, in particular when viewing the visible side. Preferably, all heating wires are made of copper or comprise predominantly copper. In spite of the possible small cross sections of the individual heating wires and the low specific resistivity of copper, it is possible here to control the overall resistance of the multicore heating conduit 9 by specific fixing of the number of heating wires, via the selection of the structure and/or cross section of the multicore heating conduit, and also via the selection and fixing of the diameters of the heating wires, and to adjust it in accordance with the requirements of the final component. As illustrated hereinafter with reference to FIGS. 16 to 20, it is thus possible to realize different multicore heating conduits 9, which can advantageously be used for a wide variety of optical effects given a sufficient heating output.

FIG. 17 illustrates in particular an example of a multicore heating conduit 9 with mutually parallel heating wires 21 and 211. The diameters of all heating wires here are preferably the same. By way of example, in the example of FIG. 17, six heating wires 211 are arranged around the heating wire 21, preferably arranged uniformly around the heating wire 21. For example, all heating wires here have a diameter of 17 μm. For example, the length of the multicore heating conduit 9 is 4 m. The material of the heating wires 21 and 211 is, for example, copper with a specific resistivity of 0.0171 Ωmm²/m. The multicore heating conduit thus has a resistance of 42.3352Ω, for example.

Further examples of a multicore heating conduit 9 are as follows, in particular with a length of the multicore heating conduit of 4 m and, for example, copper as material of the heating wires with a specific resistivity of 0.0171 Ωmm²/m:
number of heating wires: 2, diameter per heating wire 60 μm;
number of heating wires: 3, diameter per heating wire 40 μm;
number of heating wires: 4, diameter per heating wire 30 μm;
number of heating wires: 5, diameter per heating wire 24 μm;
number of heating wires: 6, diameter per heating wire 20 μm;
number of heating wires: 7, diameter per heating wire 17 μm;
number of heating wires: 8, diameter per heating wire 15 μm;
number of heating wires: 9, diameter per heating wire 13 μm;
number of heating wires: 10, diameter per heating wire 12 μm;
number of heating wires: 2, diameter per heating wire 50 μm;
number of heating wires: 3, diameter per heating wire 33 μm;
number of heating wires: 4, diameter per heating wire 25 μm;
number of heating wires: 5, diameter per heating wire 20 μm;
number of heating wires: 6, diameter per heating wire 17 μm;
number of heating wires: 7, diameter per heating wire 14 μm;
number of heating wires: 8, diameter per heating wire 13 μm;
number of heating wires: 9, diameter per heating wire 11 μm;
number of heating wires: 10, diameter per heating wire 10 μm;
number of heating wires: 2, diameter per heating wire 40 μm;
number of heating wires: 3, diameter per heating wire 27 μm;
number of heating wires: 4, diameter per heating wire 20 μm;
number of heating wires: 5, diameter per heating wire 16 μm;
number of heating wires: 6, diameter per heating wire 13 μm;
number of heating wires: 7, diameter per heating wire 11 μm;
number of heating wires: 8, diameter per heating wire 10 μm;
number of heating wires: 9, diameter per heating wire 9 μm;
number of heating wires: 10, diameter per heating wire 8 μm.

By determining the resistance of the multicore heating conduit, it is possible to ascertain the heating output of the multicore heating conduit and to configure or provide the multicore heating conduit, a control unit and/or power supply in the film body according to the requirements.

As illustrated by FIG. 17, it is possible that, at least in sections, one or more heating wires, in particular all heating wires 21 and 211, of the multicore heating conduit 9 run straight.

It is possible that the outer layers 91 of the outer heating wires 211 are of the same color. In particular, in the case of a curved multicore heating conduit 9 in the heating film composite, in the layer composite and/or in the film body, it is possible to provide, for example, a locally changing color effect and/or locally changing brightness effect. For example, the surface structure of the multicore heating conduit can be used for this purpose. For example, the surface structures in a typical viewing situation may be below the resolution capacity of the human eye, but may affect the visible color and/or brightness. Special optical effects are thus advantageously possible here, in addition to the heating function.

It is also possible that several outer layers 91 of the outer heating wires 211 are of different colors. An example of this is illustrated by FIG. 22. As described in detail in this regard, the surface structure of the multicore heating conduit 9 can be used, for example, with corresponding color differences to generate optically variable effects. In this way, further special optical effects can thus be created.

The outer layers 91 of the outer heating wires 211 of FIG. 17 are connected by way of example either directly to one another or directly to the heating wire 21. It is also possible that the outer layers 91 of the outer heating wires 211 are spaced apart from one another and/or are spaced apart from one another via outer layers of heating wires with a smaller diameter, for example the outer layers 92 of the heating wires 212 in FIG. 18, or by an interspace without further heating wires, in particular except for the heating wire 21.

Preferably, the outer layers 91 each have an insulation layer on the inside and a baking varnish layer on the outside, wherein the color of the respective outer layer is preferably determined at least by the baking varnish layer. The baking varnish layer of the outer layers 91 is bonded to the respective heating wire in particular via the insulation layer of the respective outer layer and produced by means of at least one nozzle coating and/or at least one dip coating and/or at least one spray coating and/or at least one vapor deposition operation from one or more materials from the group of thermally curable water-based hotmelt adhesives, thermally curable solvent-based hotmelt adhesives, epoxy resins, epoxy resin mixtures, especially with a layer thickness of 20 μm. The insulation layer preferably has a layer thickness within a range from 0.5 μm to 100 μm. The baking varnish layer preferably has a layer thickness within a range from 0.5 μm to 100 μm. The outer layers 90 and 91 preferably have a layer thickness within a range from 1 μm to 200 μm. As a result of the outer layers 90 and 91, there is in particular a distance between the heating wires. There is preferably a minimum distance between two or more heating wires of the heating wires 21 and 211 within a range from 0.5 μm to 10 μm. The multicore heating conduit 9 in particular has a width or a diameter within a range from 10 μm to 500 μm.

FIG. 18 shows a schematic of a multicore heating conduit 9 with heating wires of different diameter. In the example of FIG. 18, four heating wires 211 and four heating wires 212 are arranged around the heating wire 21. The heating wires 211 and 212 are arranged uniformly around the heating wire 21 by way of example, such that the cross section is in particular rotationally symmetric and axially symmetric. The heating wire 21 and the heating wires 211 here in particular have the same diameter. The heating wires 211, for example, have a first diameter, while the heating wires 212 have a second diameter corresponding to about 66% of the first diameter. For example, the first diameter of the heating wires 211 is 16 μm and the second diameter of the heating wires 212 is 11 μm. The length of the multicore heating conduit 9 is in particular 4 m. The material of the heating wires 21, 211 and 212 is, for example, copper with a specific resistivity of 0.0171 Ωmm²/m. The resistance of the multicore heating conduit 9 is thus 50.4559Ω.

Further examples of multicore heating conduits with different diameters of the heating wires in a 4 m-long multicore heating conduit comprising, for example, copper with a specific resistivity of 0.0171 Ωmm²/m as the material of the heating wires are as follows:
number of heating wires with the first diameter (heating wires 211 and heating wire 21): 5, first diameter: 20 μm, number of heating wires 212 with the second diameter: 4, second diameter: 13 μm, resistance of the multicore heating conduit: 32.2918 Ω;
number of heating wires with the first diameter (heating wires 211 and heating wire 21): 5, first diameter: 24 μm, number of heating wires 212 with the second diameter: 4, second diameter: 16 μm, resistance of the multicore heating conduit: 22.4246 Ω;

Preferably, the heating wires 211 each have an outer layer 91, as described in particular with regard to FIG. 17.

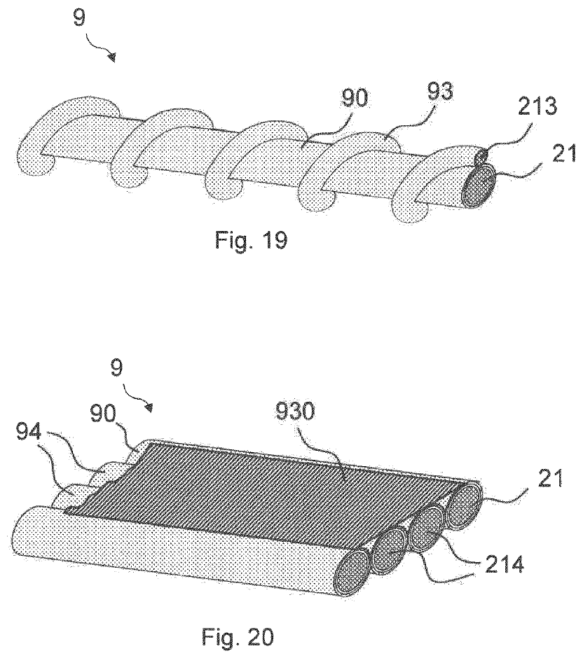

FIG. 19 shows a schematic of a multicore heating conduit 9 with the heating wire 21 and a further heating wire 213. As illustrated by FIG. 19, the heating wire 21 may be straight at least in sections. The further heating wire 213 in this example is in a twisted arrangement around the heating wire 21. Thus, the heating wire 213 has the shape of a spiral, in particular a helix. The heating wire 213 has an outer layer 93 via which it is bonded to the heating wire 21 by the outer layer 90 of the heating wire 21. The outer layer 93 may, as already described in particular for the outer layer 90 and/or the outer layer 91, have a baking varnish layer and/or an insulation layer. The twisted heating wire 213 preferably has a smaller diameter than the heating wire 21. The outer layer 93 preferably has a different color than the outer layer 90, in particular in that the outer layer 93 has a baking varnish layer and the outer layer 90 has an insulation layer, where the baking varnish layer of the outer layer 93 has a different color than the insulation layer of the outer layer 90. It is alternatively possible that, in the example illustrated by FIG. 19, the outer layer 93 and the outer layer 90 are of the same color.

It is also conceivable to position several heating wires 21 side by side with twisted heating wires 213 as illustrated by FIG. 19, in particular so as to result in a ribbon-shaped multicore heating conduit 9, preferably where a connection of two outer layers 90 of two heating wires 21 is created in each case via the outer layer 93, in particular the baking varnish layer, of a heating wire 213 positioned between the two heating wires 21. It is thus possible in particular for a plurality of mutually parallel heating wires 21 to each be connected to one another via an outer layer 93, in particular the baking varnish layer thereof, in that a heating wire 213 together with outer layer 93 extends in each case through an intermediate space between two mutually parallel heating wires 21. This results in particular in contact sites or contact surfaces between the respective outer layer 90 and the respective outer layer 93.

In this case, several outer layers 93 may be provided, which are of the same color or are of different color.

FIG. 20 shows a schematic diagram of a ribbon-shaped multicore heating conduit 9 with several parallel heating wires. In this example, the multicore heating conduit 9 has further heating wires 214 in addition to the heating wire 21. There is thus a total of four heating wires. However, it is also conceivable that there are only 2 or, for example, 6 heating wires. The heating wire 21 has the outer layer 90 and the heating wires 214 each have an outer layer 94. This results in particular in contact sites or contact surfaces between the outer layer 90 and the respective outer layer 94 or between the respective outer layers 94 that connect the heating wires 21 and 214 to one another. The outer surfaces 90 and 94 may be of the same color or of different colors. A ribbon-shaped multicore heating conduit with several identically colored and/or with several different-colored outer surfaces is thus conceivable.

In this example, the multicore heating conduit 9 additionally has a leveling layer 930, but this is optional. The leveling layer 930 here is positioned on one side of the multicore heating conduit and extends along a surface parallel to a plane which is formed by a longitudinal direction of the heating wires 21 and 214 and a direction that connects several center lines of the heating wires 21 and 214. The center lines extend in particular in the longitudinal direction. The leveling layer 930 balances out the elevations and recesses present beneath the leveling layer 930. The multicore heating conduit 9 thus has a surface leveled by the leveling layer 930. Alternatively or additionally, a leveling layer may also be positioned on the opposite side.

The leveling layer 930 preferably has one or more adhesion layers, which in particular ensures improved adhesion of the multicore heating conduit 9. Alternatively or additionally, the leveling layer 930 has one or more decorative layers, which in particular can cause additional optical effects, for example depth effects and/or optically variable effects. It is possible, for example, that the leveling layer 930 has one or more replication layers, in particular provided with a surface structure, preferably a microstructure. The leveling layer 930 is in particular a coating layer. The leveling layer 930 has been applied, for example, by means of at least one spray coating and/or at least one squeegee coating and/or at least one transfer coating and/or at least one nozzle coating and/or at least one dry coating operation to one or more materials from the group or groups of polyester, polyacrylates, PMMA, melamine, melamine-formaldehyde resins, epoxy acrylate, polyether acrylate, polyester acrylates, acrylates, epoxy polymethacrylate, polyurethane, polystyrene, polybutyrate, nitrocellulose, polyvinylchloride, ethylene-vinyl acetates, copolymers thereof or similar polymers, additives, fillers, pigments, dyes. For example, the layer thickness thereof is 150 μm. The leveling layer 930 is preferably transparent and/or colorless and/or colored.

It is possible that, in the one or more outer layers, for example outer layer 90, 91, 92, 93 and/or 94, and/or the one or more leveling layers, for example leveling layer 930 and/or a leveling layer opposite the latter, one or more recesses and/or structurings are provided, which are in particular in motif form, for example taking the form of one or more lines, an inscription and/or a logo. A motif formed by the one or more recesses and/or structurings may, for example, also extend across several outer layers, which is preferred in particular in a multicore heating conduit in ribbon form. The one or more recesses and/or structurings are or have been preferably generated by a laser ablation and/or a laser blackening. It is also possible by means of the recesses to expose one or more regions of the heating wires 21, 211, 212, 213 and/or 214, in particular such that a metal used for the heating wires is visible and/or contributes to a visible effect in the heating film composite 900, in the layer composite 2 and/or in the film body 100. In this case, the heating wires preferably remain separate from one another in that a distance is maintained between the heating wires in each case by means of the respective outer layers.

FIGS. 21a and 21b show schematic diagrams of a method of generating a contact site 922 by means of a solder site 921. In this example, the solder site 921 is created by first using the laser unit 920 to expose the heating wires 21 and 214. The laser unit 920 is preferably guided automatically, in particular by means of a robot arm. It is then possible to apply the solder site 921 using a soldering station. The soldering station is preferably guided automatically, in particular by means of the robot arm or a further robot arm. The soldering station preferably comprises at least one soldering iron and a supply of solder, for example on a roll. In particular, it is possible to automate the process of contact site creation and thus to perform a resource-sparing and reliable procedure.

For fixing of the multicore heating conduit 9, it is possible in particular that the multicore heating conduit 9 is held by means of a vacuum and/or fixed on the at least one carrier film, where the at least one carrier film is held by one or more holding means (for example by vacuum suction by means of vacuum strips).

By means of the solder site 921, a parallel connection of the otherwise galvanically isolated heating wires of the multicore heating conduit 9 may be or have been created. In this way, the contact site 922 may be or have been created, where a connection to the energy source and/or to the control unit preferably is or has been established or is establishable at the contact site 922, in particular in the film body 100. FIGS. 21a and 21b illustrate in particular a detail of one end of the multicore heating conduit 9. It is possible in particular that a contact site or solder site as illustrated with reference to FIGS. 21a and 21b also is or has been provided at the other end of the multicore heating conduit 9, which is not shown here.

FIG. 22 shows a schematic diagram of a heating film composite 900 and of a film body 100 with the heating film composite 900. In particular, a cross section is shown, where a schematic plan view may be shown, for example, similarly to that visible in FIG. 11 (on the right). The film body 100 is produced, for example, like the film body 100 of FIG. 1, except that the heating film composite 900 is or has been provided instead of the layer composite 2 or as at least part of the layer composite 2. The heating film composite 900 comprises in particular the first carrier film 20 and the multicore heating conduit 9 and may optionally also have further layers, such as the at least one decorative ply, in particular the first decorative ply 22 and/or the second decorative ply 23.

In the example illustrated by FIG. 22, the multicore heating conduit 9 is in particular a heating conduit 9 as described with regard to FIG. 17, where two of the outer layers 91 have a first color which is a different color than a second color as possessed by the rest of the outer layers 91, which is illustrated in FIG. 22 by the two patterned cross-sectional areas of the respective heating wires. A view from the top right shows thus the multicore heating output 9 in a color which is largely determined by the first color. A view from the bottom right, on the other hand, shows the multicore heating conduit 9 in a color which is largely determined by the second color. If the multicore heating conduit 9 has changes in direction, such as curves, in top view, it is possible that, when viewed at a certain viewing angle, the multicore heating conduit 9 shows a change in color according to the change in direction. It is thus possible to provide, for example, an optically variable effect, such as a preferably locally changing color effect.

It is also possible that further layers and/or layers such as the at least one decorative ply, preferably the first decorative ply 22 and/or the second decorative ply 23, are provided in the film body 100 with the multicore heating conduit 9 and/or are connected thereto. The multicore heating conduit 9 may also be provided on a reverse side of the carrier film 20. In particular, it is also conceivable that, instead of the heating wire 21 described with regard to FIGS. 1 to 15, the multicore heating conduit 9 is or has been provided and/or the heating wire 21 described with regard to FIGS. 1 to 15 is enclosed by a multicore heating conduit 9.

### LIST OF REFERENCE NUMERALS

1 first carrier component
100 film body
101 visible side
102 reverse side
2 layer composite
20 first carrier film
201 second carrier film
21 heating wire
22 first decorative ply
23 second decorative ply
26 primer layer
27 protective layer
3 second carrier component
31 protective varnish layer
4 substrate
41 reflection layer
42 first adhesive layer
43 second adhesive layer
44 light source
5 contacting element
50 contacting region
51 nonstick layer
52 contact reinforcement
70 cavity
71 first mold shape
72 second mold shape
80 slit
81 first slit shape
82 second slit shape
83 connecting element, screw
9 multicore heating conduit
90, 91, 92 outer layers
211, 212, 213, 214 further heating wires
900 heating film composite
901 insulation layer
902 baking varnish layer
920 laser unit
921 solder site
922 contact site
930 leveling layer

1. A method of producing a film body having a heatable surface of a cover element, the method comprising the following steps:
a) providing:
at least one carrier film,
at least one decorative ply and
at least one heating wire having a minimum width and/or a smallest diameter of 50 μm and a minimum cross-sectional area of 2500 μm²
or providing:
at least one carrier film,
at least one decorative ply, and
a multicore heating conduit comprising at least one heating wire and one or more further heating wires, where the at least one heating wire and the one or more further heating wires are at least partly galvanically isolated from one another,
b) in-mold coating or flow coating the at least one carrier film, the at least one heating wire and/or the at least one decorative ply with a first free-flowing composition to obtain a first carrier component of the film body;
c) applying a second free-flowing composition to a front side proceeding from the at least one carrier film to obtain a second carrier component on a visible side of the film body and/or a protective varnish layer on a visible side of the film body.

2. The method as claimed in claim 1, wherein,
in step a) the at least one carrier film, the at least one decorative ply and the at least one heating wire are provided in the form of a layer composite, or wherein, in step a) the at least one carrier film and the at least one heating wire and/or the multicore heating conduit are provided in the form of a first composite.

3. The method as claimed in claim 1, wherein
the at least one heating wire and the at least one decorative ply and/or the multicore heating conduit have been or are arranged so as to be at least partly visible when viewed from the visible side.

4. The method as claimed in claim 1, wherein
the at least one heating wire and/or the multicore heating conduit has been or is arranged directly adjacent to the second carrier component or to the protective varnish layer.

5. The method as claimed in claim 1, wherein
a minimum distance within a range from 0.2 mm to 4 mm is or has been formed between the at least one heating wire and the heatable surface and/or between the multicore heating conduit and the heatable surface.

6-7. (canceled)

8. The method as claimed in claim 1, wherein
step c) includes one or more of the following steps:
c1) overmolding the at least one carrier film with the second free-flowing composition in the form of a plastic injection molding material to obtain the second carrier component,
c2) flow coating the at least one carrier film with the second free-flowing composition which comprises or consists of polyurethane to obtain the second carrier component,
c3) painting the at least one carrier film with the second free-flowing composition, and/or painting the at least one carrier film, with a third free-flowing composition to obtain a protective varnish layer.

9. The method as claimed in claim 1, wherein
step c3) is conducted by wet painting.

10. The method as claimed in claim 1, wherein
the second free-flowing composition comprises or consists of a 2K varnish.

11. The method as claimed in claim 1, wherein
the protective varnish has a layer thickness within a range from 5 μm to 20 μm.

12. The method as claimed in claim 1, wherein
the first carrier component has a layer thickness within a range from 50 μm to 2000 μm.

13. The method as claimed in claim 1, wherein
the second carrier component has a layer thickness within a range from 200 μm to 40000 μm.

14. The method as claimed in claim 1, wherein
the film body and/or the layer composite and/or the first composite and/or the at least one carrier film is or has been provided with or has a contacting element.

15-16. (canceled)

17. A method of producing a heating film composite, the method comprising the steps of:
providing at least one carrier film,
providing at least one decorative ply and
providing a multicore heating conduit comprising at least one heating wire and one or more further heating wires, wherein the at least one heating wire and the one or more further heating wires are at least partly galvanically isolated from one another,
bonding the at least one carrier film and the multicore heating conduit and the at least one decorative ply.

18. A method of producing a layer composite, the method comprising the steps of:
i) providing at least one carrier film,
ii) providing at least one decorative ply and
iii) providing at least one heating wire having a minimum width and/or a smallest diameter of 50 μm and a minimum cross-sectional area of 2500 μm² and/or a multicore heating conduit comprising at least one heating wire and one or more further heating wires, wherein the at least one heating wire and the one or more further heating wires are at least partly galvanically isolated from one another,
iv) bonding the at least one carrier film, the at least one decorative ply and the at least one heating wire.

19. The method as claimed in claim 1, wherein
a first side of the at least one carrier film is or has been provided with at least one first decorative ply and the at least one heating wire and/or the multicore heating conduit, and wherein a second side of the at least one carrier film opposite the first side is or has been provided with at least one further decorative ply wherein the first side constitutes either a front side or a reverse side of the at least one carrier film.

20. The method as claimed in claim 1, wherein
one or more decorative plies of at least one decorative ply are or have been applied over the full area or in motif form to the at least one carrier film.

21. The method as claimed in claim 1, wherein,
for provision of the at least one heating wire in step iii) and/or the multicore heating conduit in step III), the at least one heating wire is provided in the form of a wire mesh and
is provided on the at least one carrier film.

22. (canceled)

23. The method as claimed in claim 1, wherein
the at least one heating wire and/or the multicore heating conduit is or has been at least partly inserted into or applied to one or more layers of the layer composite and/or the heating film composite, and/or the at least one heating wire and/or the multicore heating conduit is or has been inserted between two layers of the layer composite and/or the heating film composite.

24. The method as claimed in claim 1, wherein
the following step is conducted:
a1) at least partly inserting the at least one heating wire and/or the multicore heating conduit into the at least one carrier film.

25. The method as claimed in claim 1, wherein
the following step is conducted:
a2) at least partly inserting the at least one heating wire and/or the multicore heating conduit between two layers of the layer composite and/or of the heating film composite.

26. The method as claimed in claim 1, wherein
the at least one heating wire and/or the multicore heating conduit is or has been inserted with a penetration depth within a range from 20% to 100%, of its thickness into the at least one carrier film and/or into the at least one decorative ply and/or into the layer composite and/or into the heating film composite.

27. The method as claimed in claim 1, wherein
the at least one heating wire and/or the multicore heating conduit passes completely through one or more decorative plies of the at least one decorative ply.

28. The method as claimed in claim 1, wherein,
for the bonding in step iv) and/or in step IV), penetration by the at least one heating wire and/or the multicore heating conduit is conducted by ultrasound.

29. The method as claimed in claim 1, wherein
the at least one heating wire and/or the multicore heating conduit covers an area within a range from 0.1% to 50% of the layer composite and/or of the heating film composite and/or of the first carrier film.

30. (canceled)

31. The method as claimed in claim 1, wherein
the at least one carrier film comprises a first carrier film and a second carrier film, wherein a substrate comprising at least one reflection layer is or has been arranged between the first carrier film and the second carrier film, and wherein the at least one heating wire and/or the multicore heating conduit is or has been arranged between the first carrier film and the substrate or between the second carrier film and the substrate.

32. The method as claimed in claim 1, wherein
one or more decorative plies of the at least one decorative ply are or have been positioned between the first carrier film and the substrate and/or between the second carrier film and the substrate.

33-36. (canceled)

37. A heating film composite comprising
at least one carrier film and
a multicore heating conduit comprising at least one heating wire and one or more further heating wires, where the at least one heating wire and the one or more further heating wires are at least partly galvanically isolated from one another, and
at least one decorative ply,
wherein the at least one carrier film and the at least one heating wire and the at least one decorative ply are bonded.

38. A layer composite comprising
at least one carrier film,
at least one decorative ply and
at least one heating wire having a minimum width and/or a smallest diameter of 50 μm and a minimum cross-sectional area of 2500 μm² and/or a multicore heating conduit comprising at least one heating wire and one or more further heating wires, wherein the at least one heating wire and the one or more further heating wires are at least partly galvanically isolated from one another,
wherein the at least one carrier film, the at least one decorative ply and the at least one heating wire are bonded.

39. (canceled)

40. The layer composite as claimed in claim 38, wherein,
the at least one heating wire and/or the multicore heating conduit has one or more outer layers, each of which at least partly encases one or more heating wires of the at least one heating wire and/or of the one or more further heating wires.

41. The layer composite as claimed in claim 38, wherein
one or more first outer layers of the one or more outer layers have a first color and wherein one or more second outer layers of the one or more outer layers have a second color other than the first color.

42-47. (canceled)

48. A film body having a heatable surface of a cover element comprising at least one carrier film, at least one decorative ply and at least one heating wire having a minimum width and/or a smallest diameter of 50 μm and a minimum cross-sectional area of 2500 μm² and/or comprising at least one carrier film, at least one decorative ply, and a multicore heating conduit comprising at least one heating wire and one or more further heating wires, wherein the at least one heating wire and the one or more further heating wires are at least partly galvanically isolated from one another.

49-51. (canceled)
